(19) United States
(12) Patent Application Publication
(10) Pub. No.: US 2026/0235726 A1
(43) Pub. Date: Aug. 13, 2026

(54) TARGET DETECTION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Takahiro HIGUCHI, Nisshin-shi (JP); Kazuya MIURA, Nisshin-shi (JP); Koichi OYAMA, Nisshin-shi (JP)

(21) Appl. No.: 19/416,568

(22) Filed: Dec. 11, 2025

(30) Foreign Application Priority Data
Feb. 7, 2025 (JP) 2025-019480

(51) Int. Cl. G01S 7/48; G01S 13/42; G01S 13/931

(52) U.S. Cl. CPC G01S 7/4802; G01S 13/426; G01S 13/931

(57) ABSTRACT

A target detection device includes a light source, an emitting unit including an optical phased array, a detecting circuit, and a controller. The optical phased array emits irradiation light in different emission directions within a scan region. The detecting circuit receive a reflected light from the target, determine whether the target exists based on whether a peak value of a received signal is equal to or greater than a detection determination threshold, and detect a direction in which the target exists. The controller controls the emission directions, determine, based on the received signal, whether the detected target within the scan region is a highly reflective object, estimate, based on the received signal, a size of the highly reflective object, and, upon determining that the target detected in a specified direction is a highly reflective object, change the detection determination thresholds for remaining directions other than the specified direction.

### CROSS REFERENCE TO RELATED APPLICATION

The present application claims the benefit of priority from Japanese Patent Application No. 2025-019480 filed on Feb. 7, 2025. The entire disclosure of the above application is incorporated herein by reference.

### TECHNICAL FIELD

The present disclosure relates to a target detection device.

### BACKGROUND ART

There is a target detection device which emits irradiation light toward the front of a vehicle and detects objects in front of the vehicle by detecting reflected light from the objects.

### SUMMARY

According to one aspect of the present disclosure, a target detection device configured to detect a target is provided. The target detection device includes a light source, an emitting unit, a detecting circuit, and a controller. The light source is configured to generate light. The emitting unit includes an optical phased array configured to emit the light generated by the light source as an irradiation light in different emission directions within a scan region. The detecting circuit is configured to receive a reflected light from the target, determine whether the target exists within the scan region for each of the emission directions based on whether a peak value of a received signal representing an intensity of the reflected light is equal to or greater than a detection determination threshold that is set for each of the emission directions, and detect a direction among the emission directions in which the target exists. The controller includes at least one of (i) a circuit and (ii) a processor with a memory comprising a computer program code executable by the processor. The at least one of the circuit and the processor may be configured to cause the controller to control the emission directions of the emitting unit to scan the scan region, determine, based on the received signal, whether the detected target within the scan region is a highly reflective object that exhibits high reflectance to the irradiation light, estimate, based on the received signal, a size of the highly reflective object, and upon determining that the target detected in a specified direction among the emission directions within the scan region by the detecting circuit is a highly reflective object, set the detection determination thresholds for remaining directions other than the specified direction, based on: (i) the received signals of the reflected lights that are emitted in the remaining directions and reflected from the highly reflective object; (ii) the estimated size of the highly reflective object; (iii) a distribution of emission intensity of the emitting unit when emitting the irradiation light; and (iv) a distribution of light-receiving sensitivity of the detecting circuit for the reflected lights.

### BRIEF DESCRIPTION OF DRAWINGS

FIG. 1 is a diagram showing a state in which a vehicle to which a target detection device according to the first embodiment is applied and a highly reflective object exists in a scan region.

FIG. 2 is an explanatory diagram for explaining frame scanning of the target detection device according to the first embodiment.

FIG. 3 is a schematic block diagram of the target detection device according to the first embodiment.

FIG. 4 is a schematic block diagram of an optical IC included in the target detection device according to the first embodiment.

FIG. 5 is a diagram showing an example of a digital signal output by an analog-to-digital converter according to the first embodiment.

FIG. 6 is a diagram showing an example of a spectrum signal output by a Fast Fourier Transform unit according to the first embodiment.

FIG. 7 is a flowchart of a detection process executed by the target detection device according to the first embodiment.

FIG. 8 is an explanatory diagram for explaining a main lobe and side lobes contained in irradiated light.

FIG. 9 is an explanatory diagram for explaining a signal strength of reflected light from the main lobe, a signal strength of the reflected light from the side lobes, and detection threshold values.

FIG. 10 is an explanatory diagram for explaining false detection in a direction where a highly reflective object is not present, when a highly reflective object exists.

FIG. 11 is an explanatory diagram for explaining the necessity of changing the detection determination thresholds.

FIG. 12 is an explanatory diagram for explaining that false detection can be suppressed by changing the detection determination thresholds.

FIG. 13 is a diagram showing a specific example of emitting irradiation light toward directions in which a highly reflective object is present.

FIG. 14 is an explanatory diagram for explaining the emission intensity and light receiving sensitivity of the target detection device.

FIG. 15 is a diagram showing an example of an emission beam profile and a reception beam profile.

FIG. 16 is an explanatory diagram for explaining the detection determination thresholds changed by the target detection device according to the first embodiment.

FIG. 17 is a diagram showing a state in which a highly reflective object and a person are present in the scan region.

FIG. 18 is a diagram showing a state in which the main lobe is irradiated toward a person present in the scan region, and the side lobe is emitted toward a highly reflective object.

FIG. 19 is a diagram showing a state in which a person is present within the scan region of the frame scanning by the target detection device according to the first embodiment.

FIG. 20 is an explanatory diagram for explaining a method of detecting a person present in the scan region in a state where the detection determination thresholds are changed.

FIG. 21 is a schematic configuration diagram of a target detection device according to the second embodiment.

FIG. 22 is an explanatory diagram for explaining frame scanning and re-scanning of the target detection device according to the second embodiment.

FIG. 23 is a flowchart showing the detection processing executed by the target detection device according to the second embodiment.

FIG. 24 is an explanatory diagram for explaining frame scanning of the target detection device according to the first modification of the second embodiment.

FIG. 25 is an explanatory diagram for explaining the beam diameter of irradiation light emitted by the target detection device according to the second modification of the second embodiment.

FIG. 26 is an explanatory diagram for explaining frame scanning and re-scanning of the target detection device according to the third embodiment.

FIG. 27 is an explanatory diagram for explaining frame scanning and re-scanning of the target detection device according to a modification of the third embodiment.

FIG. 28 is a flowchart showing the detection processing executed by the target detection device according to the fourth embodiment.

FIG. 29 is an explanatory diagram for explaining frame scanning and re-scanning of the target detection device according to a modification of the fourth embodiment.

FIG. 30 is a flowchart showing the detection processing executed by the target detection device according to the fifth embodiment.

FIG. 31 is an explanatory diagram for explaining frame scanning and re-scanning of the target detection device according to a modification of the fifth embodiment.

FIG. 32 is a flowchart showing the detection processing executed by the target detection device according to the sixth embodiment.

FIG. 33 is a diagram for explaining frame scanning and re-scanning of the target detection device according to a modification of the sixth embodiment.

### DESCRIPTION OF EMBODIMENTS

To begin with, examples of relevant techniques will be described.

There is a target detection device which emits irradiation light toward the front of a vehicle and detects objects in front of the vehicle by detecting reflected light from the objects. The target detection device is known as a LiDAR for detecting a target. LiDAR is an abbreviation for Light Detection and Ranging, or Laser Imaging Detection and Ranging. The target detection device emits irradiation light in a predetermined measurement direction and receives and analyzes the reflected light from a target, thereby measuring the direction and distance of the target.

However, a highly reflective object with a relatively high reflectance, such as a retroreflector, reflects light more strongly compared to an object that is not highly reflective. When the target detection device receives such strong reflected light, errors may occur in measurement results such as the direction and distance of the target measured by the target detection device, resulting in decreased detection accuracy. To address this issue, there is a target detection device configured to stop emitting of irradiation light for a predetermined period when receiving reflected light from a highly reflective object to prevent occurrence of range aliasing caused by receiving reflected light from highly reflective objects, thereby suppressing the decrease in detection accuracy.

However, the target detection device described above stops emitting irradiation light for a predetermined period, and thus cannot detect the object during the predetermined period. Thus, the detection capability and detection accuracy of the target detection device may decrease with the method of stopping the emission of irradiation light as in the target detection device described above.

In view of the above, the present disclosure provides a target detection device configured to improve detection accuracy.

According to one aspect of the present disclosure, a target detection device configured to detect a target is provided. The target detection device includes a light source, an emitting unit, a detecting circuit, and a controller. The light source is configured to generate light. The emitting unit includes an optical phased array configured to emit the light generated by the light source as an irradiation light in different emission directions within a scan region. The detecting circuit is configured to receive a reflected light from the target, determine whether the target exists within the scan region for each of the emission directions based on whether a peak value of a received signal representing an intensity of the reflected light is equal to or greater than a detection determination threshold that is set for each of the emission directions, and detect a direction among the emission directions in which the target exists. The controller includes at least one of (i) a circuit and (ii) a processor with a memory comprising a computer program code executable by the processor. The at least one of the circuit and the processor is configured to cause the controller to control the emission directions of the emitting unit to scan the scan region, determine, based on the received signal, whether the detected target within the scan region is a highly reflective object that exhibits high reflectance to the irradiation light, estimate, based on the received signal, a size of the highly reflective object, and upon determining that the target detected in a specified direction among the emission directions within the scan region by the detecting circuit is a highly reflective object, set the detection determination thresholds for remaining directions other than the specified direction, based on: (i) the received signals of the reflected lights that are emitted in the remaining directions and reflected from the highly reflective object; (ii) the estimated size of the highly reflective object; (iii) a distribution of emission intensity of the emitting unit when emitting the irradiation light; and (iv) a distribution of light-receiving sensitivity of the detecting circuit for the reflected lights.

The target detection device may receive reflected light from a highly reflective object in a scan region even if the emission direction of the irradiation light is set to a direction other than the specified direction in which the highly reflective object exists. The detection determination threshold for a direction other than the specified direction in which the highly reflective object exists can be set corresponding to the highly reflective object by setting the detection determination threshold for the direction using the received signal of the reflected light from the highly reflective object. Thus, even when the emission direction is set to a direction other than the specified direction in which the highly reflective object exists and reflected light from the highly reflective object is received, it is possible to suppress erroneous detection that an object exists in the set direction based on the received signal of the reflected light from the highly reflective object.

In addition, the detection determination threshold can be set appropriately by setting the detection determination threshold for the remaining directions other than the specified direction in which the highly reflective object exists, based on the size of the highly reflective object, the distribution of emission intensity of the emission unit, and the distribution of light-receiving sensitivity of the detecting unit. Thus, erroneous detection that an object exists in the set direction is further suppressed. Accordingly, the target detection device can detect objects with high accuracy.

Hereinafter, embodiments of the present disclosure will be described with reference to the drawings. In the following embodiments, parts that are identical or equivalent to those described in the preceding embodiments are denoted with the same reference numerals, and descriptions thereof may be omitted. Furthermore, in the embodiments, when only a part of a component is described, the components described in the preceding embodiments can be applied to the other parts of the component. The following embodiments may be partially combined with one another, even if not explicitly stated, as long as there is no particular impediment to such combinations.

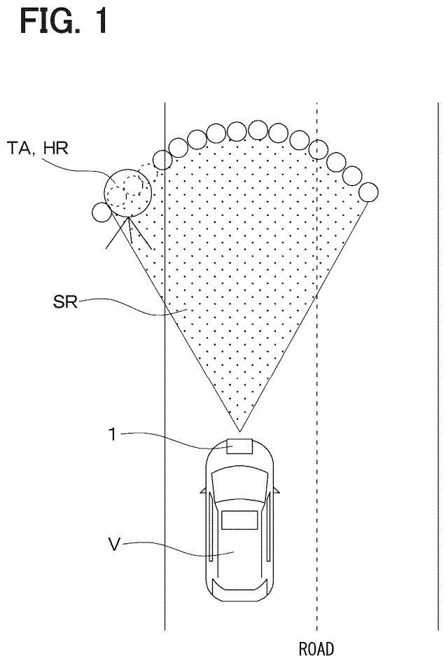

(First Embodiment) This embodiment will be described with reference to FIGS. 1 to 20. In this embodiment, an example in which a target detection device 1 of the present disclosure is applied to a vehicle V, as shown in FIG. 1, will be described. The target detection device 1 is a sensor configured to emit an infrared beam, which serves as irradiation light, into a scan region SR indicated by the dotted hatching in FIG. 1, and detect a target TA, which is a detection target present within the scan region SR.

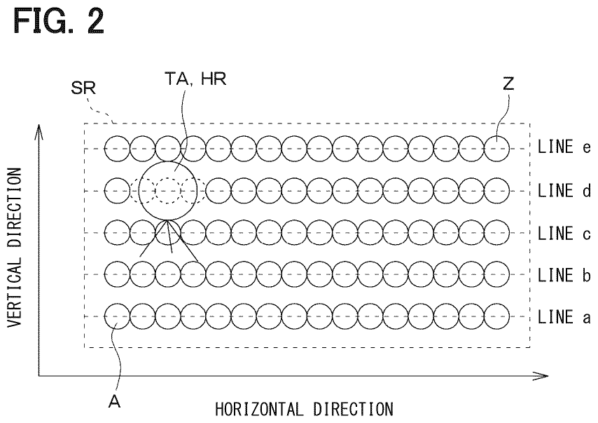

When the target detection device 1 is applied to the vehicle V, the target detection device 1 emits irradiation light toward targets TA such as other vehicles, pedestrians, and stationary objects present around the vehicle V, and measures the distance and direction to the targets TA by receiving reflected light from the targets TA. The target detection device 1 may be a LIDAR. LiDAR is also referred to as a laser radar. Hereinafter, the vehicle V equipped with the target detection device 1 according to the present embodiment is also referred to as a host vehicle. It should be noted that the circles shown in FIGS. 1 and 2 represent the directions of the irradiation light emitted by the target detection device 1 and the beam diameter of the irradiation light.

The target detection device 1 may be mounted on the inside of the front bumper in the traveling direction of the host vehicle. The target detection device 1 emits irradiation light toward the front of the host vehicle and receives reflected light from a target TA within the scan region SR, thereby acquiring object information such as the distance and direction of the target TA present around the host vehicle. The target detection device 1 of the present embodiment detects various objects such as other vehicles, pedestrians, and stationary objects as described above, and also highly reflective objects HR such as retroreflectors shown in FIG. 1.

The highly reflective object HR refers to one of targets TA that is formed from a material with relatively high reflectivity and easily reflects irradiation light, and is defined as an object that reflects light with higher intensity compared to other objects different from the highly reflective object HR. Examples of the highly reflective object HR include road signs, lane markings, vehicles, trucks, bicycles, and reflectors on the front, sides, and rear of vehicles. In FIGS. 1 and 2, the directions and beam diameter of the irradiation light emitted toward the highly reflective object HR are indicated by dashed circles, and the directions and beam diameter of irradiation light emitted toward directions other than the direction in which the highly reflective object HR is present are indicated by solid circles.

The target detection device 1 of the present embodiment detects a target TA within the scan region SR shown in FIG. 2 by emitting irradiation light while emission direction toward the front of the host vehicle. The scan region SR shown in FIG. 2 represents a scan region that is orthogonal to the direction toward the front of the host vehicle. As shown in FIG. 2, the target detection device 1 of the present embodiment performs one scan by sequentially changing the emission direction of the irradiation light from the measurement start direction A (i.e., start emission direction) to the measurement end direction Z (i.e., end emission direction) within the scan region SR.

Hereinafter, the process in which the target detection device 1 scans the scan region SR once from the measurement start direction A to the measurement end direction Z within the scan region SR will be referred to as a “frame scanning.” In addition, within the frame scanning, the process in which the target detection device 1 scans a single scan line extending in the straight direction is referred to as a “line scanning.” In the present embodiment, an example will be described in which one frame scan is performed by conducting five line scans in the horizontal direction. In FIG. 2, for the sake of convenience in explanation, five scan lines that constitute a frame scan are shown, and these are referred to as lines a through e in order from the bottom to the top of FIG. 2.

For example, the target detection device 1 starts scanning from the leftmost direction of the line a as the measurement start direction A of the frame scan. Then, the target detection device 1 horizontally scans along the line a, and continues scanning in order from the line a through line e. The scan ends at the rightmost direction of the line e as the measurement end direction Z of the frame scanning. In FIG. 2, a highly reflective object HR, which is the target TA, is present within the scan region SR.

The target detection device 1 of the present embodiment adopts the FMCW (Frequency Modulated Continuous Wave) method to determine the distance and direction to the target TA. However, the target detection device 1 may also determine the distance and direction to the target TA using the TOF (Time of Flight) method or the FCM (Fast-Chirp Modulation) method.

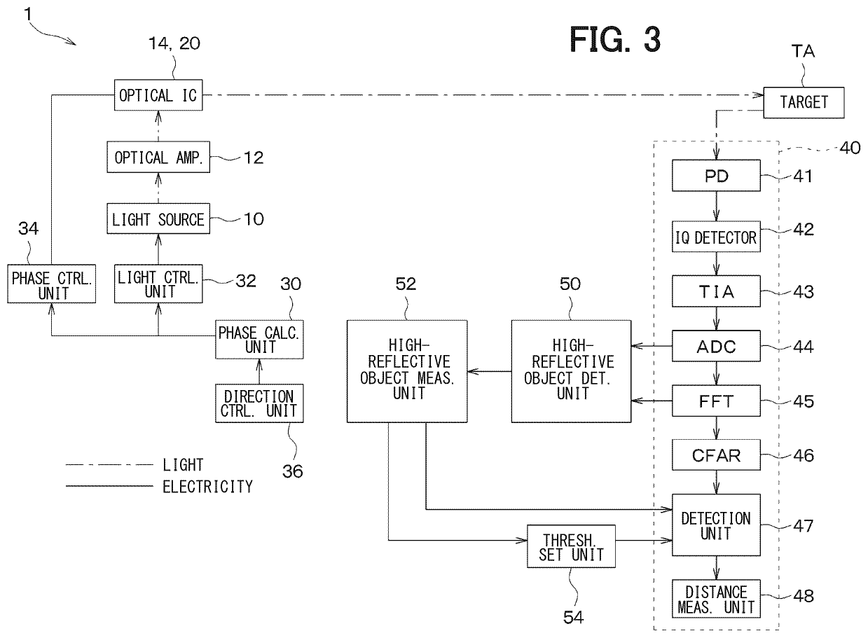

As shown in FIG. 3, the target detection device 1 includes a light source 10, an optical amplifier 12, an optical IC 14, a phase calculation unit 30, a light source control unit 32, a phase control unit 34, a direction control unit 36, a detecting unit 40, a highly reflective object determination unit 50, a highly reflective object measurement unit 52, and a threshold setting unit 54. In FIG. 3, the arrows drawn with dash-dot lines indicate the flow of light, while the arrows drawn with solid lines indicate various processing signals and various control signals.

The light source 10 is a light generating unit configured to generate light. In the target detection device 1 of the present embodiment, which detects the target TA using the FMCW method, the light source 10 varies the frequency of the irradiation light according to the passage of time. The light source 10 is driven under the control of the light source control unit 32, and the frequency of the generated frequency-modulated continuous wave is adjusted.

The optical amplifier 12 amplifies the light generated by the light source 10. The optical amplifier 12 outputs the amplified light to the optical IC 14. Light amplified by the optical amplifier 12 is incident on the optical IC 14. The optical IC 14 serves as an emitting unit configured to emit, as irradiation light, the light incident from the optical amplifier 12.

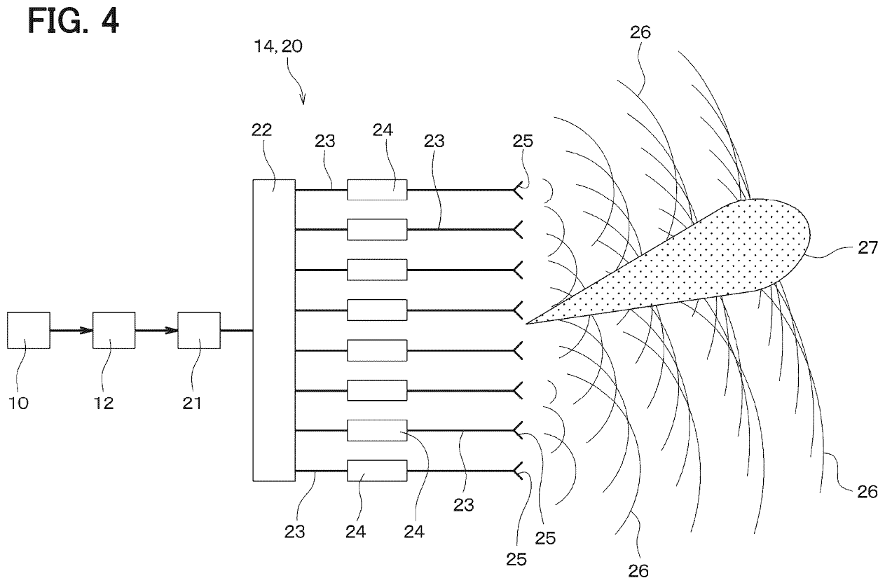

As shown in FIG. 4, the optical IC 14 constitutes an optical phased array 20 (hereinafter referred to as “OPA 20”). OPA is an abbreviation for Optical Phased Array. The OPA 20 is a device configured to freely control the direction and beam diameter of the beam emitted from the optical IC 14 without using mechanical components such as movable mirrors.

The OPA 20 includes an optical emission unit 21, an optical splitter 22, multiple optical waveguides 23, multiple phase adjustment units 24, and multiple optical antennas 25, and is formed on a silicon substrate (not shown). Light emitted from the light source 10 is incident on the optical emission unit 21 via the optical amplifier 12. The optical splitter 22 distributes the light incident on the optical emission unit 21 to the optical waveguides 23 arranged in an array. The optical waveguides 23 guide the light distributed by the optical splitter 22 to the optical antennas 25 provided at the tips of each of the optical waveguides 23. The phase adjustment units 24 provided along the optical waveguides 23 are phase shifters configured to control the phase of light passing through the optical waveguides 23 by changing the refractive index of the optical waveguides 23. The light whose phase has been controlled by the phase adjustment units 24 is emitted from the optical antennas 25.

The OPA 20 can emit an irradiation beam 27, which is emitted as irradiation light, in any desired direction by controlling the phase of the light passing through the optical waveguides 23 with the phase adjustment units 24 for the diffraction and interference of light waves 26 emitted from the optical antennas 25. In addition, the OPA 20 can adjust the beam diameter and beam intensity of the irradiation beam 27 by controlling the phase of the light passing through the optical waveguides 23 with the phase adjustment units 24. The beam diameter corresponds to the diameter in a cross-section perpendicular to the direction in which the irradiation beam 27 is emitted. The beam intensity corresponds to the irradiation intensity of the irradiation beam 27. The greater the beam intensity, the longer the detectable range of the target detection device 1, and the weaker the beam intensity, the shorter the detectable range of the target detection device 1.

The phase control unit 34 shown in FIG. 3 controls the driving of the phase adjustment units 24 included in the OPA 20. Specifically, the phase control unit 34 is configured to change the direction of the irradiation beam by controlling the phase adjustment units 24 of the OPA 20 to control the phase of light propagating through the optical waveguides 23, and to adjust the intensity of the beam per unit volume by changing the beam diameter. More specifically, the phase control unit 34 and the OPA 20 is configured to reduce the beam intensity by expanding the beam diameter or increase the beam intensity by narrowing the beam diameter, through phase control that includes nonlinearization or randomization of the phase shift amount. The phase control unit 34 adjusts the emission direction and beam diameter of the irradiation light during frame scanning.

The phase calculation unit 30 is configured to calculate the phase of the light propagating through the optical waveguides 23 so that the irradiation light emitted from the optical IC 14, namely, the irradiation beam 27, has a set direction and a set beam diameter within the scan region SR. In this embodiment, the phase calculation unit 30 calculates the phase of the light propagating through the optical waveguides 23 so that the direction of the irradiation light emitted by the optical IC 14 is sequentially changed from the direction A to the direction Z in the scan region SR as described above.

Additionally, when scanning each of the lines a to e in the horizontal direction, the phase calculation unit 30 calculates the phase of the light propagating through the optical waveguides 23 such that the beam diameters of the irradiation light emitted in directions at a predetermined position do not overlap with each other and no gaps occur between the beam diameters. The phase calculation unit 30 calculates the phase of the light propagating through the optical waveguides 23 so that the beam diameters for each of the lines a to e are arranged at regular intervals. Specifically, when scanning each of the lines a to e in the horizontal direction, the phase calculation unit 30 calculates the phase of the light propagating through the optical waveguides 23 so that the beam diameter emitted in each direction is approximately circular and uniform. The phase calculation unit 30 outputs the calculation result information of the phase of light, calculated as described above, to the light source control unit 32 and the phase control unit 34.

The light source control unit 32 controls the light source 10 based on the signals input from the phase calculation unit 30. Specifically, the light source control unit 32 adjusts the frequency of the light generated by the light source 10. As a result, the light generated by the light source 10 passes through the optical amplifier 12 and the optical IC 14, and is emitted from each of the optical antennas 25 of the OPA 20.

The phase control unit 34 controls the phase adjustment units 24 of the optical IC 14 based on the signals input from the phase calculation unit 30. As a result, the direction and beam diameter of the irradiation light emitted from the OPA 20 during frame scanning are determined.

The direction control unit 36 issues instructions to the phase calculation unit 30 to calculate the phase of the light passing through the optical waveguides 23. Specifically, the direction control unit 36 sets target emission direction and beam diameter of the irradiation light, and instructs the phase calculation unit 30 to calculate the phase of the light necessary to ensure that the irradiation light emitted from the optical IC 14 has the target direction and beam diameter. As described above, the direction control unit 36 is configured to set the target emission direction and beam diameter of the irradiation light emitted by the OPA 20 of the optical IC 14, and controls the emission direction and beam diameter via the phase calculation unit 30 and the phase control unit 34 to scan the scan region SR. The direction control unit 36 outputs a command signal to the phase calculation unit 30 to have the phase calculation unit 30 calculate the phase as needed.

The phase calculation unit 30, the light source control unit 32, the phase control unit 34, the direction control unit 36, the highly reflective object determination unit 50, the highly reflective object measurement unit 52, and the threshold setting unit 54 may be implemented by a microcontroller equipped with a CPU, non-volatile memory such as flash memory, and volatile memory such as RAM. In such a case, the phase calculation unit 30, the light source control unit 32, the phase control unit 34, the direction control unit 36, the highly reflective object determination unit 50, the highly reflective object measurement unit 52, and the threshold setting unit 54 realize various processes described later by having the CPU execute programs recorded in the non-volatile memory and use the volatile memory as a work area during execution. Alternatively, the phase calculation unit 30, the light source control unit 32, the phase control unit 34, the direction control unit 36, the highly reflective object determination unit 50, the highly reflective object measurement unit 52, and the threshold setting unit 54 may be dedicated circuits having a circuit configuration designed to carry out the various processes described later.

As shown in FIG. 3, the irradiation light emitted from the optical IC 14 is reflected by the target TA and enters the detecting unit 40 of the target detection device 1 as reflected light. The detecting unit 40 may include a photodiode 41 (hereinafter referred to as “PD 41”), an IQ detecting unit 42, and a transimpedance amplifier 43 (hereinafter referred to as “TIA 43”). The detecting unit 40 further includes an analog-to-digital converter 44 (hereinafter referred to as “ADC 44”), a fast Fourier transform unit 45 (hereinafter referred to as “FFT 45”), a CFAR 46, a detection determination unit 47, and a distance measurement unit 48. It should be noted that PD, IQ, TIA, ADC, FFT, and CFAR are abbreviations for Photodiode, In-phase and Quadrature, Trans Impedance Amplifier, Analog-to-Digital Converter, Fast Fourier Transform, and Constant False Alarm Rate, respectively.

The PD 41 photoelectrically converts the reflected light incident on the detecting unit 40 and outputs a current signal corresponding to the intensity of the reflected light. That is, the reflected light incident on the detecting unit 40 is photoelectrically converted by the PD 41. The intensity of the reflected light that can be received by the detecting unit 40 is predetermined according to the specifications of the PD 41. In other words, the light receiving sensitivity of the detecting unit 40 is predetermined depending on the PD 41. The PD 41 outputs a current signal corresponding to the intensity of the reflected light to the IQ detecting unit 42.

The light receiving unit that receives the reflected light incident on the detecting unit 40 may be configured as a phased array, similar to the OPA 20 of the optical IC 14. In this case, the phased array that receives the reflected light is configured to include an optical input section, multiple waveguides through which the reflected light passes, and a phase shifter configured to adjust the phase of the light passing through the waveguides. The beam diameter that the detecting unit 40 can receive, that is the light-receiving sensitivity can be set by adjusting the phase of light propagating through the waveguides with the phase shifter.

The IQ detecting unit 42 performs signal processing on the voltage signal input from the PD 41 using the in-phase and quadrature components. The IQ detecting unit 42 performs so-called quadrature detection processing on the voltage signal input from the PD 41, and outputs the processed signal to the TIA 43.

The TIA 43 amplifies the weak current signal input from the IQ detecting unit 42 and converts the signal into a voltage signal. By converting the current signal into a voltage signal, the TIA 43 outputs a voltage signal corresponding to the intensity of the reflected light to the ADC 44.

The ADC 44 converts the analog signal input from the TIA 43 into a digital signal. The ADC 44 converts the analog signal input from the TIA 43 into a digital signal, and outputs the converted digital signal to both the FFT 45 and the highly reflective object determination unit 50.

The FFT 45 performs frequency analysis on the digital signal corresponding to the intensity of the reflected light input from the ADC 44. The FFT 45 performs frequency analysis through fast Fourier transform processing on the digital signal input from the ADC 44, and outputs the frequency-analyzed information as a spectral signal to both the CFAR 46 and the highly reflective object determination unit 50. The digital signal output by the ADC 44 and the spectral signal output by the FFT 45 correspond to the received signal representing the intensity of the reflected light received by the detecting unit 40.

The CFAR 46 extracts the peak values of the signal intensity based on the signal that has been frequency-analyzed by the FFT 45. The CFAR 46 obtains peak values that are equal to or greater than a predetermined spectral determination threshold, which is set in advance, from the spectral signal input from the FFT 45, and outputs information regarding the obtained peak values to the detection determination unit 47.

The detection determination unit 47 determines whether a target TA is present within the scan region SR, based on the peak value information input from the CFAR 46. The detection determination unit 47 determines whether a target TA is present within the scan region SR based on whether the peak value input from the CFAR 46 is equal to or greater than a predetermined detection determination threshold Dth, which will be described later. The detection determination threshold Dth is a threshold set to determine whether a target TA exists within the scan region SR, and serves as a reference determination value established to avoid false detections caused by noise. When the detection determination unit 47 determines that a target TA exists within the scan region SR, the detection determination unit 47 outputs the determination result to the distance measurement unit 48.

The distance measurement unit 48 measures the distance to the target TA based on the result of the determination process performed by the detection determination unit 47. When the detection determination unit 47 determines that a target TA exists within the scan region SR, the distance measurement unit 48 measures the distance and direction to the target TA that reflected the irradiation light, based on the spectral signal output from the FFT 45.

The highly reflective object determination unit 50 detects a highly reflective object HR within the scan region SR by determining whether the target TA that reflected the reflected light is a highly reflective object HR. The highly reflective object determination unit 50 determines whether the target TA that reflected the reflected light is a highly reflective object HR, based on the digital signal representing the intensity of the reflected light input from the ADC 44. Alternatively, the highly reflective object determination unit 50 determines whether the target TA that reflected the reflected light is a highly reflective object HR, based on the spectral signal respresenting the intensity of the reflected light input from the FFT 45. The highly reflective object determination unit 50 of the present embodiment determines whether the target TA that reflected the reflected light is a highly reflective object HR, based on at least one of the digital signal or the spectral signal.

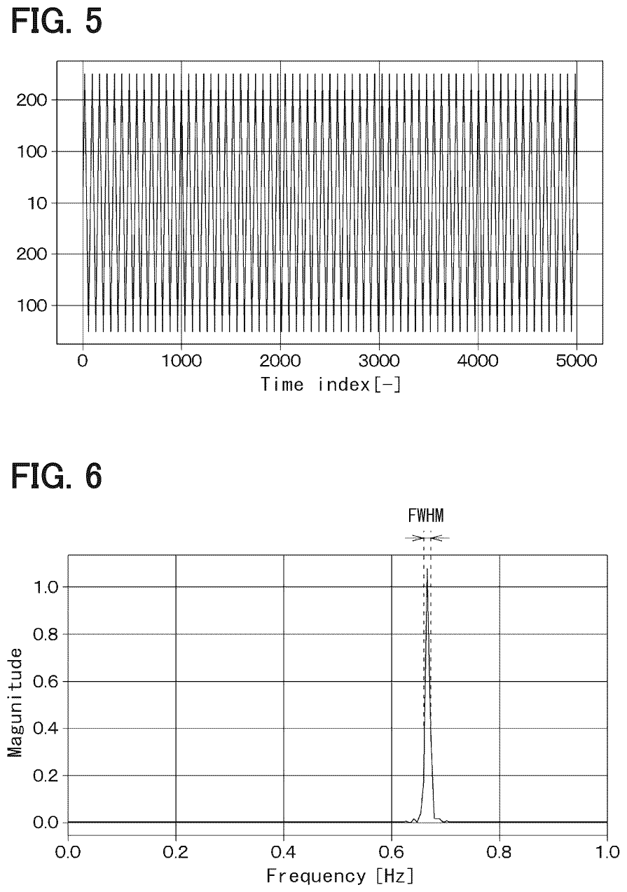

When making the determination based on the digital signal, the highly reflective object determination unit 50 may determine whether the target TA is a highly reflective object HR based on whether the peak value of the amplitude of the digital signal shown in FIG. 5 is equal to or greater than a predetermined voltage value. When making the determination based on the spectral signal, the highly reflective object determination unit 50 may determine whether the target TA is a highly reflective object HR based on whether the peak value of the magnitude, which indicates the intensity of the spectral signal shown in FIG. 6, is equal to or greater than a predetermined amplitude value. The magnitude, which indicates the intensity of the spectral signal, is the amplitude of the spectral signal. Alternatively, when making the determination based on the spectral signal, the highly reflective object determination unit 50 may determine whether the target TA is a highly reflective object HR based on whether the width of the frequency domain (for example, full width at half maximum: FWHM) including the peak value of the spectral signal is equal to or greater than a predetermined frequency width. Hereinafter, various determination thresholds used to determine whether the target TA that reflected the reflected light is a highly reflective object HR are referred to as highly reflective object determination thresholds.

The highly reflective object determination unit 50 may determine that the target TA is a highly reflective object HR when determining that the target TA is a highly reflective object HR based on both the digital signal input from the ADC 44 and the spectral signal input from the FFT 45. Alternatively, the highly reflective object determination unit 50 may determine that the target TA is a highly reflective object HR when determining that the target TA is a highly reflective object HR based on at least one of the digital signal input from the ADC 44 or the spectral signal input from the FFT 45.

When the highly reflective object determination unit 50 determines, based on these digital signals and spectral signals, that a highly reflective object HR exists within the scan region SR, the highly reflective object determination unit 50 outputs the determination result to the highly reflective object measurement unit 52.

The highly reflective object measurement unit 52 estimates the size of the highly reflective object HR within the scan region SR. The highly reflective object measurement unit 52 calculates an estimated size of the highly reflective object HR based on the information used by the highly reflective object determination unit 50 for determining the highly reflective object HR. Specifically, the highly reflective object measurement unit 52 estimates the horizontal width of the highly reflective object HR based on the directional information of the highly reflective object HR detected when the highly reflective object determination unit 50 determines that the highly reflective object HR is present. The highly reflective object measurement unit 52 outputs the calculated size information of the highly reflective object HR to the threshold setting unit 54 and the detection determination unit 47. Details regarding the method for calculating the size of the highly reflective object HR performed by the highly reflective object measurement unit 52 will be described later.

The threshold setting unit 54 sets a detection determination threshold Dth for each of emission directions in the scan region SR that is used by the detection determination unit 47 to determine whether a target TA exists within the scan region SR. When the threshold setting unit 54 receives the size information of the highly reflective object HR from the highly reflective object measurement unit 52, the threshold setting unit 54 sets the detection determination thresholds Dth based on the size information of the highly reflective object HR, and outputs the information of the set detection determination thresholds Dth to the detection determination unit 47. The details of the detection determination thresholds Dth set by the threshold setting unit 54, as well as the details of the method for setting the detection determination thresholdw Dth, will be described later.

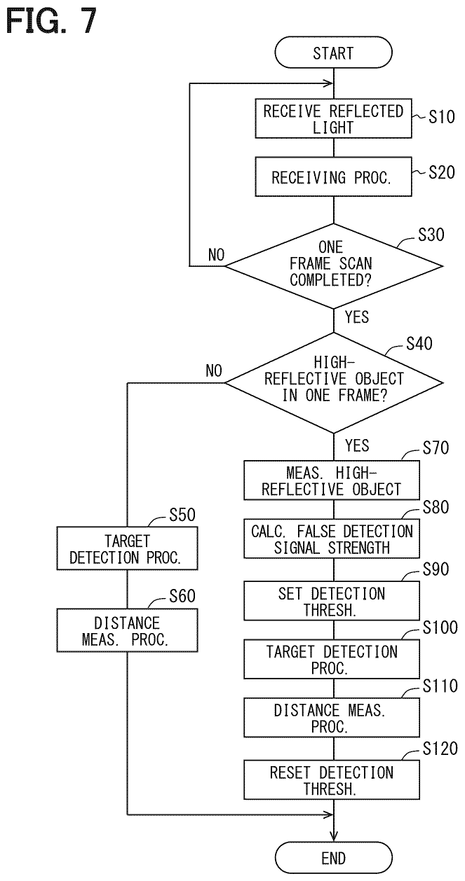

Next, the operation of the target detection device 1 according to the present embodiment will be described with reference to the detection processing shown in FIG. 7. The target detection device 1 performs the detection processing shown in FIG. 7 to determine the distance and direction to the target TA present within the scan region SR. When the target detection device 1 executes the detection processing, the direction control unit 36 first sets the emission directions and beam diameter of the irradiation light for frame scanning, and outputs a command signal to the phase calculation unit 30 to calculate the optical phase necessary to obtain the set emission directions and beam diameter. Upon receiving this command signal, the phase calculation unit 30 calculates the optical phase for each of the optical waveguides 23 necessary to emit irradiation light with the set beam diameter in the set emission directions. Then, the phase calculation unit 30 outputs the information of the calculated optical phase to the light source control unit 32 and the phase control unit 34.

The light source control unit 32 controls the light source 10 based on the signal input from the phase calculation unit 30. The phase control unit 34 controls the phase adjustment units 24 of the optical IC 14 based on the signal input from the phase calculation unit 30, thereby adjusting the emission directions and beam diameter of the irradiation light emitted from the OPA 20. As a result, the light generated by the light source 10 is emitted from the OPA 20 through the optical amplifier 12 and the optical IC 14 to scan the scan region SR shown in FIG. 2. Specifically, the target detection device 1 emits beams sequentially from the leftmost direction A of the line a toward the right in the horizontal direction to scan the line a, and performs similar scanning for the lines b through e in this order. The target detection device 1 emits beams up to the rightmost direction Z of the line e.

When the irradiation light emitted in some directions are reflected by the target TA during the frame scanning, the detecting unit 40 receives the reflected light from the directions. The target detection device 1 repeatedly executes the detection process shown in FIG. 7 each time frame scanning is performed.

First, in step S10, the detecting unit 40 receives the reflected light. Then, in step S20, the detecting unit 40 performs various light-receiving processes on the received reflected light. Specifically, the PD 41 photoelectrically converts the incident reflected light and outputs a current signal corresponding to the intensity of the reflected light to the IQ detecting unit 42. The IQ detecting unit 42 performs quadrature detection processing on the voltage signal input from the PD 41 and outputs the processed signal to the TIA 43. The TIA 43 converts the weak current signal input from the IQ detecting unit 42 into an amplified voltage signal and outputs the voltage signal to the ADC 44. The ADC 44 converts the analog signal input from the TIA 43 into a digital signal, and outputs the digital signal to the FFT 45 and the highly reflective object determination unit 50. The FFT 45 performs frequency analysis by executing fast Fourier transform processing on the digital signal input from the ADC 44, and outputs the spectral signal to the CFAR 46 and the highly reflective object determination unit 50. The CFAR 46 obtains the peak value of the signal strength based on the spectral signal input from the FFT 45 and the spectral determination threshold, and outputs the information of the obtained peak value to the detection determination unit 47.

Additionally, the highly reflective object determination unit 50 determines whether the target TA, which reflects the irradiated light, is a highly reflective object HR, based on the digital signal input from the ADC 44, the spectral signal input from the FFT 45, and the highly reflective object determination threshold. When the highly reflective object determination unit 50 determines that the target TA is a highly reflective object HR, the highly reflective object determination unit 50 outputs the determination result to the highly reflective object measurement unit 52.

These signal processing executed in the light reception processing of step S20 are performed each time the detecting unit 40 receives reflected light. Then, in step S20, the detecting unit 40 performs the light reception processing each time reflected light is received, until the frame scanning is completed. Specifically, the detecting unit 40 performs light reception processing each time the detecting unit 40 receives reflected lights of irradiation lights emitted from the leftmost direction of the line a to the rightmost direction of the line e during the frame scanning shown in FIG. 2. Then, the detecting unit 40 calculates the peak value of the spectrum signal for the reflected light from each of the directions within the scan region SR, and determines whether the target TA that reflects the light is a highly reflective object HR. The determination result determined by the highly reflective object determination unit 50 may be stored in the highly reflective object measurement unit 52. In step S30, when it is determined that the frame scanning has been completed, the process proceeds to step S40.

In step S40, the detecting unit 40 determines whether there is any reflected light from a highly reflective object HR within the single frame during the frame scanning. That is, in step S40, the detecting unit 40 determines whether a highly reflective object HR present within the scan region SR. The detecting unit 40 may determine whether a highly reflective object HR is present within the scan region SR based on whether there is at least one of the determination results from the highly reflective object determination unit 50, which are stored in the highly reflective object measurement unit 52, indicates that the reflected light is reflected from a highly reflective object HR.

When it is determined that none of the reflected light from any direction within the scan region SR is from a highly reflective object HR, the detecting unit 40 proceeds the processing to step S50. That is, when it is determined that no highly reflective object HR exists within the scan region SR, the detecting unit 40 proceeds the processing to step S50. On the other hand, when it is determined that at least one of the reflected lights from the directions within the scan region SR is reflected light from a highly reflective object HR, the detecting unit 40 proceeds the processing to step S70. That is, when it is determined that a highly reflective object HR exists within the scan region SR, the detecting unit 40 proceeds the processing to step S70.

In S50, the detecting unit 40 performs a target detection process in step S50, and performs a distance measurement process for the target TA in step S60. Specifically, in step S50, the detection determination unit 47 determines whether the peak value input from the CFAR 46 is equal to or greater than the detection determination threshold Dth. Then, when the detection determination unit 47 determines that the peak value is equal to or greater than the detection determination threshold Dth, the detection determination unit 47 determines that a target TA exists in the direction from which the reflected light corresponding to the peak value is received. When the detection determination unit 47 determines that a target TA exists, the detection determination unit 47 outputs the information of the determination result to the distance measurement unit 48.

In step S70, the distance measurement unit 48 performs distance measurement processing based on the result of the determination processing performed by the detection determination unit 47. The distance measurement unit 48 measures the distance and direction to the target TA that reflected the irradiation light, based on the peak value of the spectral signal output from the FFT 45. The distance measurement unit 48 calculates the distance and direction to the target TA using methods such as the FMCW method, FCM method, or TOF method.

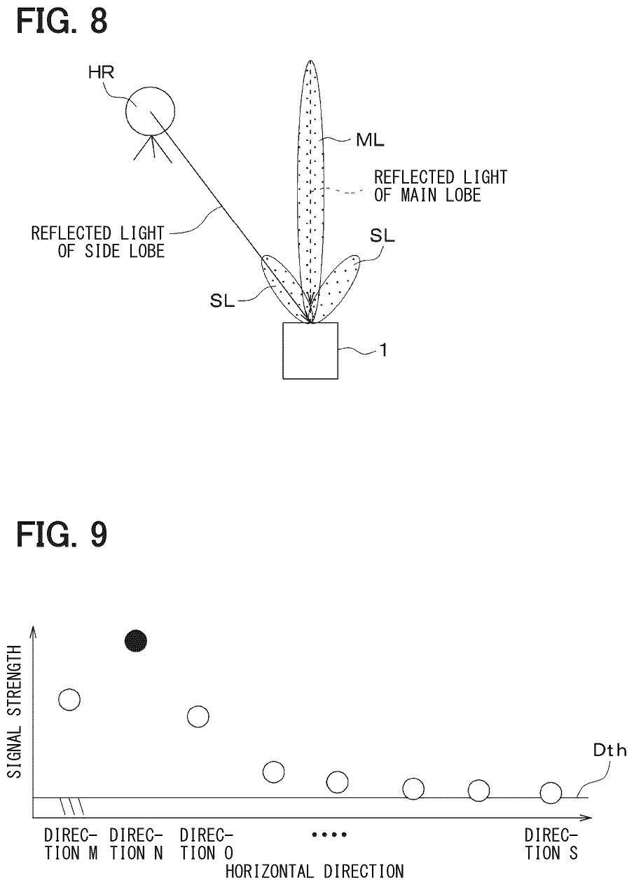

When it is determined that a highly reflective object HR exists within the scan region SR through these processes, the detecting unit 40 executes the processing from step S70 to step S120. The reason why the processing executed by the detecting unit 40 differs depending on whether it is determined that a highly reflective object HR exists within the scan region SR or not, as described above, will be explained with reference to FIGS. 8 to 12.

When the target detection device 1 is configured to emit light from the OPA 20, which is formed as a phased array, the emitted light includes not only the main lobe ML but also side lobes SL that are emitted in directions different from the main lobe ML as shown in FIG. 8. The main lobe ML is a beam emitted in the desired direction set by controlling the phase of light passing through each of the optical waveguides 23 by the phase adjustment units 24. In contrast, the side lobes SL are beams emitted toward both sides of the direction in which the main lobe ML is emitted. The side lobes SL are unnecessary irradiation light not used by the target detection device 1 to detect the target TA.

As shown in FIG. 8, the beam intensity of the side lobes SL is weaker than that of the main lobe ML. Additionally, the side lobes SL have a shorter beam projection distance compared to the main lobe ML. Thus, the target detection device 1 is less likely to receive the side lobes SL reflected by the target TA, compared to the main lobe ML reflected by the target TA. That is, the target detection device 1 is less likely to receive the side lobes SL reflected by a target TA located at a relatively distant position, making it difficult to detect the target TA using the side lobes SL. In contrast, the target detection device 1 can easily receive the main lobe ML reflected by the target TA even when the target TA is located at a relatively distant position, making it easier to detect the target TA using the main lobe ML.

However, when the target TA that reflects the side lobe SL is a highly reflective object HR, which has a relatively high reflectance and reflects strong reflected light, the intensity of the reflected light increases. Thus, as shown in FIG. 8, when there is no target TA in the direction in which the main lobe ML is emitted, but a highly reflective object HR is present in the direction in which the side lobe SL is emitted, the target detection device 1 may receive the side lobe SL reflected by the highly reflective object HR.

Here, suppose that when the reflected light from the highly reflective object HR is received, the peak value of the signal intensity obtained by the light receiving process of step S20 in the detection processing of FIG. 7 is equal to or greater than the detection determination threshold Dth. In this case, there is a risk of erroneously detecting that a target TA exists in the direction in which the main lobe ML is emitted even if the main lobe ML is not received from a direction where no target TA is present, due to the reception of the side lobe SL reflected by the highly reflective object HR.

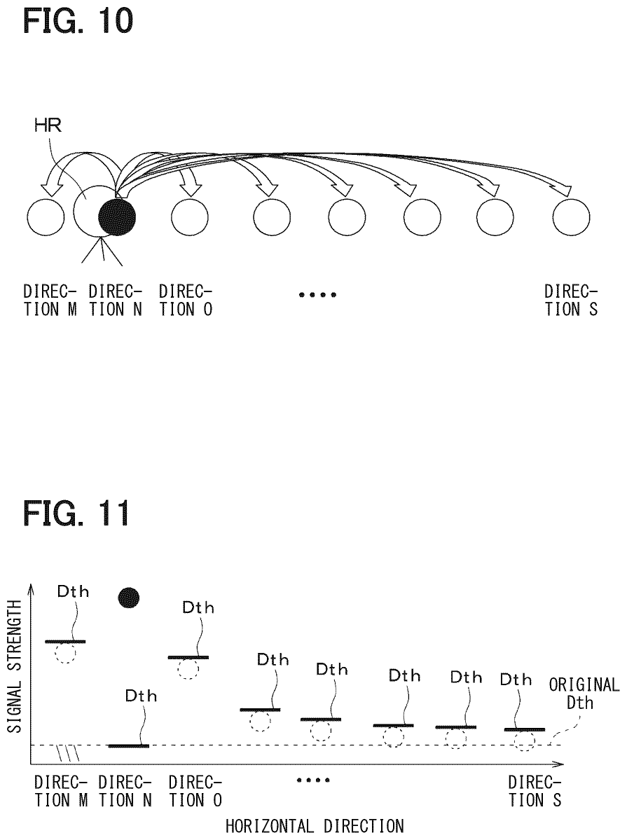

When scanning one scan line among the scan lines during frame scanning, as shown in FIGS. 9 and 10, the emission direction of the irradiation light emitted by the target detection device 1 may be changed horizontally from the direction M to the direction S via the directions N and O. The emission direction of the irradiation light emitted by the target detection device 1 is a direction set by the direction control unit 36, and is the direction in which the main lobe ML is emitted. Then, suppose that a highly reflective object HR is present in the direction N from the target detection device 1.

It should be noted that, the black circle in FIG. 9 indicates the signal strength obtained by receiving the reflected light of the main lobe ML from the direction N, where the highly reflective object HR is present, and performing the light reception processing of step S20. White circles in FIG. 9 indicate the signal strengths obtained by receiving the reflected light of the side lobe SL and performing the light reception processing of step S20, when the main lobe ML is emitted toward directions other than the direction N, where the highly reflective object HR is present. In FIG. 10, the black circle indicates the main lobe ML emitted toward the direction N, where the highly reflective object HR is present, and white circles indicate the main lobes ML emitted toward directions other than the direction N.

In such a case, when the emission direction of the irradiation light by the target detection device 1 is set to the direction N, where the highly reflective object HR is present, the reflected light from the highly reflective object HR at the specified direction N is received. Then, when the target detection device 1 identifies the signal strength through the light reception processing of step S20, the identified signal intensity is remarkably large, as shown in FIG. 9.

However, even when the emission direction of the irradiation light by the target detection device 1 is set to a direction different from the direction N, where the highly reflective object HR is present, the target detection device 1 may still receive reflected light of the side lobe SL, which has been reflected by the highly reflective object HR from the direction N. When the target detection device 1 determines the signal strength through the light reception processing of step S20, the signal strength obtained from this reflected wave may be relatively large, as shown in FIG. 9.

Specifically, when the emission direction of the irradiation light is set to the direction M just to the left of the direction N, where the highly reflective object HR is present, or to the direction O just to the right of the direction N, the signal strength determined by the light reception processing will be a value relatively close to the signal strength obtained when the emission direction is set to the direction N. Further, even when the emission direction of the irradiation light is gradually changed from the direction O toward the direction S, the signal strength identified by the light reception processing at each set direction may also be relatively large.

When the presence or absence of the target TA at each set direction is determined based on whether the signal strength corresponding to each set direction obtained in this manner is equal to or greater than the detection determination threshold Dth shown in FIG. 9, false detection will occur, resulting in determining that the target TA is present at each set direction. That is, the target detection device 1 may erroneously detects that the reflected wave is reflected from a target TA in the directions M, O to S other than the direction N where a highly reflective object HR is present, which are indicated by solid circles in FIG. 10, and erroneously detects that a target TA exists at each of the directions M and directions O through S. As a result, the detection accuracy of the target detection device 1 may be reduced.

Thus, it is necessary, as shown in FIG. 11, to increase the detection determination thresholds Dth for remaining directions other than the specified direction in which the highly reflective object HR compared to the detection determination thresholds Dth shown in FIG. 9, when a highly reflective object HR is present within the scan region SR, to prevent the occurrence of false detections. Specifically, when a highly reflective object HR is present within the scan region SR, as shown in FIG. 11, it is required that the detection determination threshold Dth for the remaining directions other than the specified direction in which the highly reflective object HR is present be set greater than the signal strength of the reflected light caused by the side lobe SL. It should be noted that, in FIG. 11, dashed circles indicate the signal strengths corresponding to the reflected lights caused by the side lobes SL.

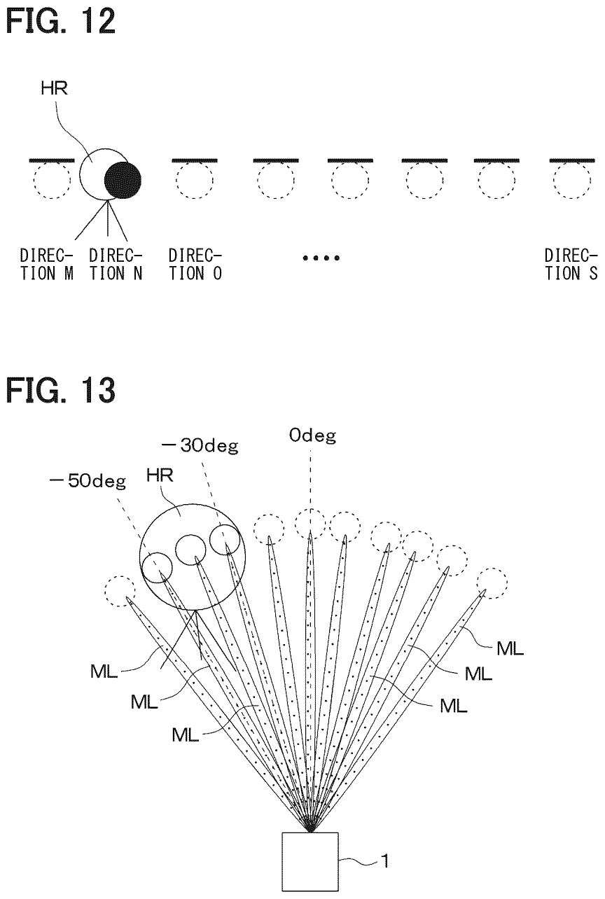

Increasing the detection determination thresholds Dth for the remaining directions in this manner can suppress false detections even when the presence of a target TA is determined based on the signal strength generated by the reception processing when the reflected light from the side lobe SL is received in the specified direction where the highly reflective object HR is present. For example, as shown in FIG. 10, even in cases where there is a risk of false detection of a target TA in the direction M and the directions O to S, it is possible to prevent false detection of a target TA in the direction M and the directions O to S, as shown in FIG. 12. It should be noted that the dashed circles in FIG. 12 indicate that, targets TA that do not exist in the direction M and the directions O to S are not falsely detected by increasing the detection determination thresholds Dth.

The specific method for setting the detection determination thresholds Dth and the method for detecting the target TA will be explained with reference to FIG. 7. When it is determined in step S40 that there is reflected light from a highly reflective object HR within a single frame, the highly reflective object measurement unit 52 calculates, in step S70, the size of the highly reflective object HR corresponding to the determination result by the highly reflective object determination unit 50 that the detected target is a highly reflective object HR. Specifically, the highly reflective object measurement unit 52 determines the distance to the highly reflective object HR and the direction to the highly reflective object HR based on the reflected light from the direction in which the highly reflective object HR is determined to be present, and calculates the size of the highly reflective object HR based on the obtained information. Here, the method for calculating the size of the highly reflective object HR will be explained using an example in which the highly reflective object HR exists across directions of −50°, −40°, and −30°, as shown in FIG. 13.

In such a case, when the target detection device 1 receives reflected light from each of the directions where the highly reflective object HR exists (i.e., −50°, −40°, and −30°), and determines the signal strength through the light reception processing executed in step S20, the significantly large signal strength is obtained for each direction. Then, when such significantly large signals exceed the highly reflective object determination threshold, the highly reflective object determination unit 50 determines that a highly reflective object HR exists at each of the directions −50°, −40°, and −30° through execution of step 40.

Then, in step S70, the highly reflective object measurement unit 52 calculates the size of the highly reflective object HR based on the result that a highly reflective object HR is determined to exist at each of the directions −50°, −40°, and −30°. Specifically, the highly reflective object measurement unit 52 calculates the distance to the highly reflective object HR using the signal strength obtained through the light reception processing in step S20. Additionally, the highly reflective object measurement unit 52 calculates the range in which the highly reflective object HR exists, using the signal strength obtained through the light reception processing in step S20.

Then, the highly reflective object measurement unit 52 calculates the width of the highly reflective object HR based on the calculated distance to the highly reflective object HR and the range in which the highly reflective object HR exists. In this way, if, during a single frame scan, the target TA present in the scan region SR is determined to be a highly reflective object HR by the highly reflective object determination unit 50, the highly reflective object measurement unit 52 estimates the size of the highly reflective object HR before the next frame scan is performed.

The highly reflective object measurement unit 52 outputs the calculated size information of the highly reflective object HR to the threshold setting unit 54 and the detection determination unit 47. When the detection determination unit 47 receives the information on the size of the highly reflective object HR from the highly reflective object measurement unit 52, the detection determination unit 47 does not execute the target detection processing in step S100, which will be described below, until the information on the detection determination thresholds Dth set by the threshold setting unit 54 is input, which will be described later.

By executing the subsequent step S80 and step S90, the threshold setting unit 54 sets the detection determination thresholds Dth, which are used by the detection determination unit 47 in step S100, described later, to determine whether the target TA is present. First, in step S80, the threshold setting unit 54 calculates the signal strength resulting from the sidelobes SL reflected by the highly reflective object HR, among the signal strengths obtained in the light reception processing of step S20, for each direction.

Specifically, the threshold setting unit 54 calculates the signal strengths of the reflected light when the sidelobes SL generated when the emission direction of the main lobe ML is set to a direction different from that in which the highly reflective object HR is determined to exist, are reflected by the highly reflective object HR. Such reflected light from the sidelobes SL that have been reflected by the highly reflective object HR is a factor that can lead to false detection. Hereinafter, the signal strength of the reflected light from the sidelobes SL, which serves as a factor for false detection, will be referred to as a false detection signal strength.

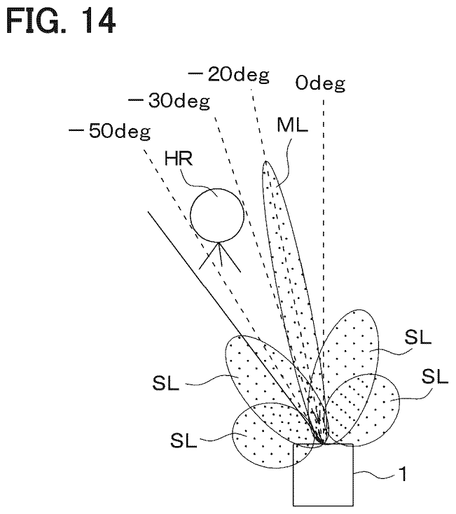

Here, the calculation method for the false detection signal strength will be described with an example where a highly reflective object HR exists across directions −50° to −30°, as shown in FIG. 13, and the emission direction of the main lobe ML is set to −20°, where the highly reflective object HR does not exist, as shown in FIG. 14. FIG. 14 shows the main lobe ML and sidelobes SL in the case where the emission direction of the main lobe ML, that is, the emission direction of the irradiation light, is set to −20°.

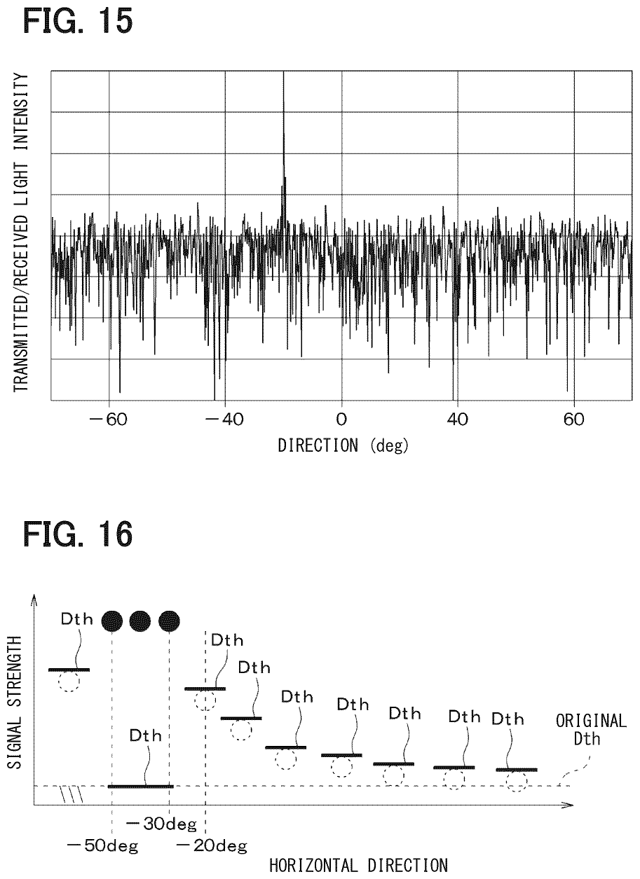

FIG. 15 shows the emission beam profile, which indicates the distribution of beam intensity of the irradiation light toward each direction when the emission direction of the main lobe ML is set to −20°, and the reception beam profile, which indicates the distribution of the reception sensitivity of reflected light from each direction. As shown in FIG. 15, the emission beam profile and the reception beam profile have beam intensity and reception sensitivity in the directions around −20°, due to the occurrence of sidelobes SL in the vicinity of the emission direction of the main lobe ML at −20°.

It should be noted that the emission beam profile and the reception beam profile are determined by the specifications of the target detection device 1. For example, the emission beam profile is determined by the specifications of each component constituting the OPA 20, which is the emission unit of the optical IC 14 configured to emit the irradiation light. The emission beam profile is a characteristic of the optical IC 14. The reception beam profile is determined by the specifications of the PD 41 of the detecting unit 40, which receives the reflected light. The reception beam profile is a characteristic of the PD 41. In the present embodiment, an example in which the emission beam profile and the reception beam profile shown in FIG. 15 are regarded as equivalent to each other will be described. However, the emission beam profile and the reception beam profile do not necessarily have to be equivalent, and the respective beam profiles may be set differently from each other.

As shown in FIG. 14, when the emission direction is set to −20°, the irradiation light is emitted at −20°, which is the emission direction of the main lobe ML. Thus, the beam intensity toward −20° and the light reception sensitivity from −20° are the strongest. However, even when the emission direction is set to −20°, side lobes SL are generated on both sides of the main lobe ML, that is, at directions smaller than-20° and greater than −20°. The farther the side lobes SL are from the emission direction of the main lobe ML at −20°, the lower their beam intensity and the lower their light reception sensitivity tend to be. However, as shown in FIG. 15, the beam intensity and light reception sensitivity of the side lobes SL do not gradually decrease as the directions moves away from the emission direction of the main lobe ML. Instead, both the beam intensity and light reception sensitivity gradually decrease while repeatedly fluctuating up and down.

The false detection signal strength when the side lobes SL are reflected by the highly reflective object HR can be determined using the distribution within the range where the highly reflective object HR is present and the amount of reflected light from the highly reflective object HR from the emission beam profile and reception beam profile, which change as described above. Specifically, the false detection signal strength can be calculated based on the following Equation 1.

$$false detection signal strength = {\int }_{{T}_{min}}^{{T}_{max}} ( transmitted light intensity distribution \times light reception sensitivity distribution ) \times reflected light amount \qquad ( Equation 1 )$$

In Equation 1, Tₘₐₓ indicates the largest direction (i.e., angle) among the directions where the highly reflective object HR is present, and Tₘᵢₙ indicates the smallest direction (i.e., angle) among the directions where the highly reflective object HR is present. In addition, the amount of reflected light in Equation 1 refers to the signal strength of the light reflected from the highly reflective object HR, and can be determined from the signal strength obtained through the light reception process of step S20 when the target detection device 1 sets the emission direction of the main lobe ML to the direction where the highly reflective object HR is present.

Then, by integrating the energy distribution of the emitted light beam profile within the range estimated to be reflected by the highly reflective object HR, it is possible to obtain the intensity distribution of the side lobes SL within the range irradiated toward the highly reflective object HR. Additionally, by integrating the energy distribution of the received light beam profile within the range estimated to be reflected by the highly reflective object HR, it is possible to obtain the light-receiving sensitivity distribution for the range in which the reflected waves caused by the side lobes SL are received from the highly reflective object HR.

For example, as shown in FIG. 13 and FIG. 14, suppose that the highly reflective object HR exists across the directions −50° to −30°. In this case, the false detection signal intensity can be calculated by multiplying the overlap integral of the emitted light beam profile and the received light beam profile within the range of the directions −50° to −30°, as shown in FIG. 15, by the amount of reflected light from the highly reflective object HR.

The threshold setting unit 54 uses Equation 1 to calculate, for each direction, the false detection signal strength caused by the side lobes SL reflected by the highly reflective object HR out of the signal strengths obtained by the reception processing in step S20.

Then, in step S90, the threshold setting unit 54 sets the detection determination thresholds Dth based on the calculated false detection signal strength for each direction, and outputs the information of the set detection determination thresholds Dth to the detection determination unit 47. Specifically, the threshold setting unit 54 sets the detection determination threshold Dth for each emission direction within the scan region SR where the irradiation light is emitted, except for the emission directions in which it is determined that the highly reflective object HR is present, based on the calculated false detection signal strength for each direction. More specifically, the threshold setting unit 54 sets the detection determination thresholds Dth for each direction where it is determined that the signal strength has increased beyond the detection determination thresholds Dth due to the side lobes SL being reflected by the highly reflective object HR, based on the false detection signal strength.

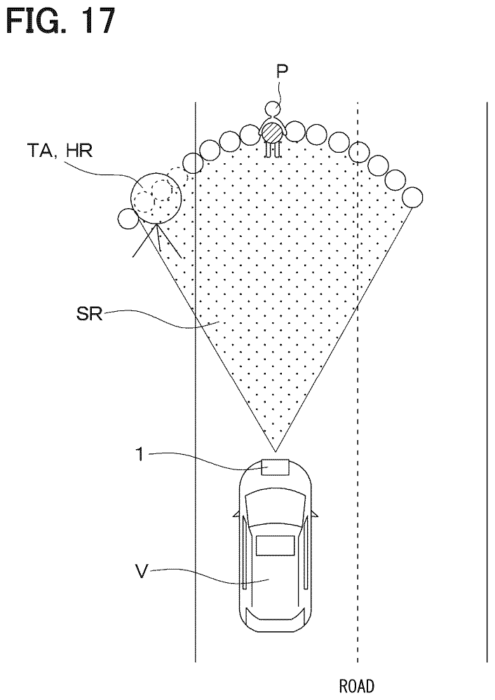

In the present embodiment, as shown in FIG. 16, the threshold setting unit 54 sets the detection determination threshold Dth for each direction, except for those determined where it is determined that the highly reflective object HR is present, to a value greater than the calculated false detection signal strength for each direction. For example, when the highly reflective object HR is present across directions from −50° to −30°, the detection determination threshold Dth for directions less than −50° and greater than −30° are each set to a value slightly greater than the false detection signal strength calculated for respective directions. The threshold setting unit 54 outputs information on the set detection determination thresholds Dth to the detection determination unit 47.

When the detection determination unit 47 receives information on the detection determination thresholds Dth from the threshold setting unit 54, the detection determination unit 47 executes the target detection processing of step S100. In the target detection processing of step S100, the detection determination unit 47 determines, as in step S50, whether the peak value input from the CFAR 46 is equal to or greater than the detection determination threshold Dth for each direction. However, in step S100, the detection determination unit 47 performs the target detection processing based on the detection determination thresholds Dth set in step S90. When the detection determination unit 47 determines that the peak value is equal to or greater than the detection determination threshold Dth set in step S90, the detection determination unit 47 determines that a target TA exists in the direction where the reflected light corresponding to the peak value is received.

In this manner, the detection determination unit 47 determines whether a target TA exists based on the detection determination thresholds Dth set in step S90. Thus, as indicated by the dashed circles in FIG. 16, even if reflected light from the side lobes SL is received from directions less than −50° or greater than −30°, false detection of target TA in these directions can be suppressed. In other words, false detection of the target TA caused by the side lobes SL can be suppressed.

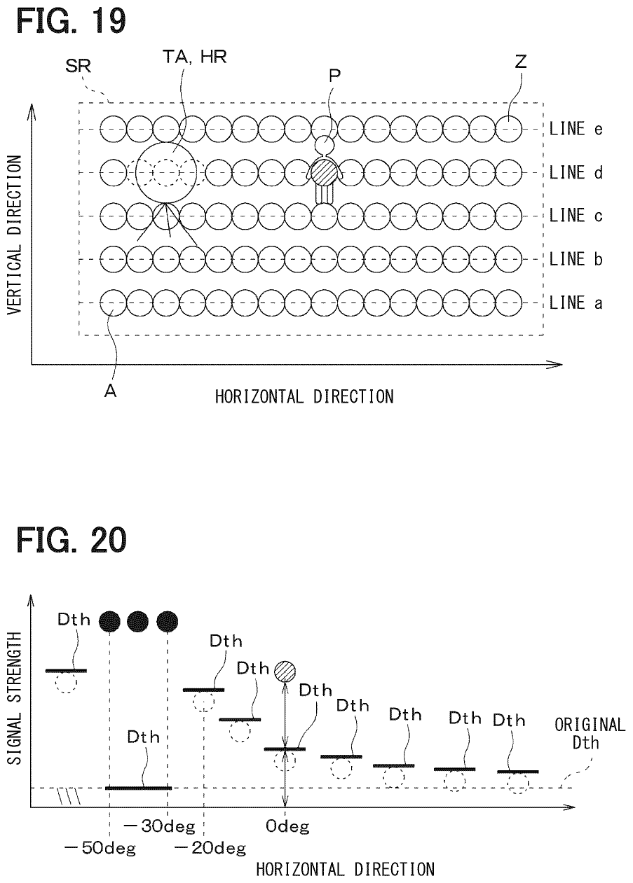

Next, as shown in FIGS. 17 to 19, a case will be described in which a person P exists as a target TA within the scan region SR. It should be noted that the circles with hatched shading shown in FIGS. 17 and 19 indicate the irradiation light emitted toward the direction in which the person P is present, or the reflected light reflected by the person P.

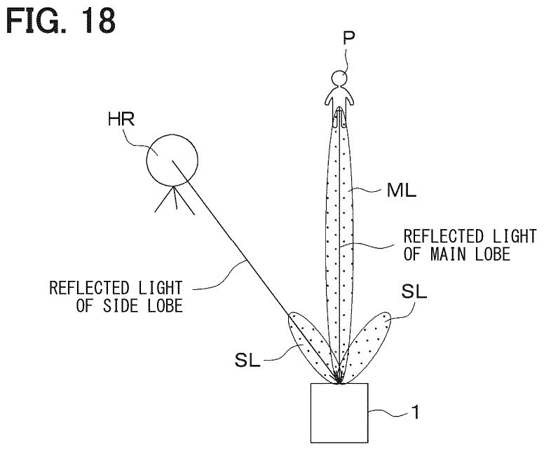

As shown in FIGS. 17 and 18, it is assumed that the person P is present at 0°, which is a direction different from the direction in which the highly reflective object HR is located. Further, as shown in FIGS. 17 and 19, it is assumed that a person P is present within the scan region SR. In this case, when the main lobe ML emitted from the target detection device 1 toward the direction in which the person P is present (0° in this example) is reflected by the person P, the target detection device 1 receives this reflected light from 0°, where the person P is present. Furthermore, when the side lobes SL, which are generated on both sides of the main lobe ML emitted from the target detection device 1 toward the direction where the person P is present, are reflected by the highly reflective object HR, the target detection device 1 receives this reflected light from the direction in which the highly reflective object HR is present. Thus, when both the highly reflective object HR and the person P are present within the scan region SR, and the emission direction of the irradiation light is set to the direction in which the person P is present, the main lobe ML reflected by the person P and the side lobe SL reflected by the highly reflective object HR are received.

Then, it is assumed that these two types of the reflected light are received, and the signal strengths of the reflected lights are determined through the light reception processing of step S20. Accordingly, as shown in FIG. 20, when the emission direction is set to 0°, the signal strength is the sum of the signal strengths corresponding to the reflected light from the main lobe ML reflected by the person P and the reflected light from the side lobes SL reflected by the highly reflective object HR. That is, the signal strength will be greater than in the case where the highly reflective object HR is absent, by an amount corresponding to the erroneous detection signal strength caused by the side lobes SL reflected by the highly reflective object HR.

Thus, even when the detection determination threshold Dth for the direction in which the person P is present is set slightly higher than the erroneous detection signal strength through the processing of step S90, the signal strength based on the reflected light from the person P will exceed the detection determination threshold Dth set in step S90. Accordingly, even in a case where the detection determination unit 47 determines the presence of the person P based on whether the peak value of the signal strength derived from the reflected light from the person P is equal to or greater than the detection determination threshold Dth set in step S90, the presence of the person P can be detected. That is, even when the detection determination unit 47 detects the presence of the person P based on the detection determination threshold Dth that has been increased compared to the case where the highly reflective object HR is absent, the presence of the person P can still be accurately detected.

When the detection determination unit 47 determines in step S100 that the target TA is present by such a target detection process, the detection determination unit 47 outputs information on the determination result to the distance measurement unit 48. Then, in step S110, the distance measurement unit 48 performs distance measurement processing based on the result of the determination processing executed by the detection determination unit 47, in the same manner as in step S60. The distance measurement unit 48 measures the distance and direction to the target TA that reflected the irradiation light, based on the peak value of the spectral signal output from the FFT 45.

Thereafter, in step S120, the threshold setting unit 54 resets and initializes the detection determination thresholds Dth. That is, the threshold setting unit 54 sets the detection determination thresholds Dth to the value of the detection determination thresholds Dth that are set before step S90. Then, the target detection device 1 ends the detection process.

As described above, the target detection device 1 of the present embodiment includes the light source 10 configured to generate light, and the OPA 20 configured to emit the light generated by the light source 10 as irradiation light. In addition, the target detection device 1 includes the direction control unit 36 configured to control the emission direction of the irradiation light emitted by the OPA 20, thereby scanning within the scan region SR. Furthermore, the target detection device 1 includes the detecting unit 40 configured to receive the reflected light reflected from a target TA, and determine whether the target TA exists based on whether the peak value of the received signal representing the intensity of the received reflected light is equal to or greater than the detection determination threshold Dth which is set for each direction in the scan region SR. In addition, the target detection device 1 includes the highly reflective object determination unit 50 configured to determine whether the target TA present in the scan region SR is a highly reflective object HR based on the received signal, and the highly reflective object measurement unit 52 configured to estimate the size of the highly reflective object HR based on the received signal. Furthermore, the target detection device 1 includes the threshold setting unit 54 configured to set the detection determination thresholds Dth. When the detecting unit 40 detects that the target TA exists in a specified direction, and the highly reflective object determination unit 50 determines that the target TA in the specified direction is a highly reflective object HR, the threshold setting unit 54 sets the detection determination thresholds Dth for remaining directions other than the specified direction based on: (i) the received signals of the reflected lights from the highly reflective object HR received when the emission direction of the irradiation light are set to the remaining directions other than the specified direction, (ii) the estimated size of the highly reflective object HR as determined by the highly reflective object measurement unit 52, (iii) the emission beam profile of the OPA 20, and (iv) the reception beam profile of the PD 41.

As described above, when a highly reflective object HR is present in a specified direction within the scan region SR, the target detection device 1 may receive reflected light from the highly reflective object HR even when the emission direction of the irradiation light is set to a direction other than the specified direction. In such cases, the detection determination thresholds Dth for the remaining directions other than the specified direction in which the highly reflective object HR is present is set based on the received signal of the reflected light from the highly reflective object HR, the size of the highly reflective object HR, the emission beam profile, and the reception beam profile. As a result, the detection determination thresholds Dth for the remaining directions other than the specified direction can be adjusted to correspond to the highly reflective object HR. Thus, even when the emission direction of the irradiation light is set to a direction other than the specified direction and reflected light from the highly reflective object HR is received from the set direction, it is possible to suppress erroneous detection of the target TA as being present in the set direction, based on the received signal of the reflected light from the highly reflective object HR.

Further, by setting the detection determination thresholds Dth for the remaining directions other than the specified direction in which the highly reflective object HR is present, based on the size of the highly reflective object HR, the emission beam profile, and the reception beam profile, the detection determination thresholds Dth can be appropriately set. Thus, erroneous detection of the target TA as being present in the set direction can be more easily suppressed. Accordingly, the target detection device 1 can detect the target TA with high accuracy.

When a highly reflective object HR is present in a specified direction within the scan region SR, there are means for suppressing the influence of receiving reflected light from the highly reflective object HR, such as reducing the beam intensity of the irradiation light or temporarily stopping the emission of the irradiation light for a predetermined period. However, when the beam intensity of the irradiation light is reduced, the detectable distance of the target detection device 1 becomes shorter, which may lead to a decrease in the detection accuracy of the target detection device 1. In addition, when the emission of the irradiation light is stopped, the target TA cannot be detected during the period in which the emission is stopped, which may result in a decrease in the detection capability and detection accuracy of the target detection device 1.

In contrast, the target detection device 1 of the present embodiment can avoid a decrease in detection accuracy caused by reducing the beam intensity of the irradiation light or stopping the emission of the irradiation light.

Furthermore, the target detection device 1 of the present embodiment sets the detection determination thresholds Dth using the size of the highly reflective object HR. Furthermore, the shape of the highly reflective object HR is not constant and may vary. In the present embodiment, the detection determination thresholds Dth can be adapted to highly reflective objects HR of various shapes by setting the detection determination thresholds Dth using the size of the highly reflective object HR. Thus, the detection accuracy of the target detection device 1 can be further improved.

Additionally, according to the above embodiment, the following effects can be obtained.

(1) In the above embodiment, the highly reflective object measurement unit 52 estimates the size of the highly reflective object HR based on the distance to the highly reflective object HR and the direction from which the reflected light from the highly reflective object HR is received.

By estimating the size of the highly reflective object HR in this manner, the estimation accuracy of the highly reflective object HR can be improved.

(2) In the above embodiment, the threshold setting unit 54 sets the detection determination thresholds Dth for the remaining directions other than the specified direction in which the highly reflective object HR is present to be greater than the signal strength received from the specified direction in which the highly reflective object HR is present when the emission direction is set to the remaining directions.

Accordingly, when the emission direction is set to a direction other than the specified direction where the highly reflective object HR is present, it becomes easier to further suppress erroneous detection of a target TA in the set emission direction based on the reflected light from the highly reflective object HR.

(3) In the above embodiment, the phase control unit 34 changes the beam diameter of the irradiation light by either making the phase shift amount of the irradiation light non-linear or randomizing the phase shift amount.

Accordingly, the beam diameter of the irradiation light can be easily adjusted.

(4) In the above embodiment, when the highly reflective object determination unit 50 determines that the target TA present in the scan region SR is a highly reflective object HR during a single frame scan, the highly reflective object measurement unit 52 estimates the size of the highly reflective object HR before the next frame scan starts.

Accordingly, compared to the case where the size of the highly reflective object HR is estimated based on the results of the frame scan performed after the frame scan in which the target TA is determined to be a highly reflective object HR, the elapsed time until the size of the highly reflective object HR is estimated can be reduced.

(5) In the above embodiment, the highly reflective object determination unit 50 determines whether the target TA is a highly reflective object HR based on at least one of the amplitude of the digital signal, the amplitude of the spectral signal, or the half-width of the spectral signal.

Accordingly, the determination accuracy of the highly reflective object HR can be improved.

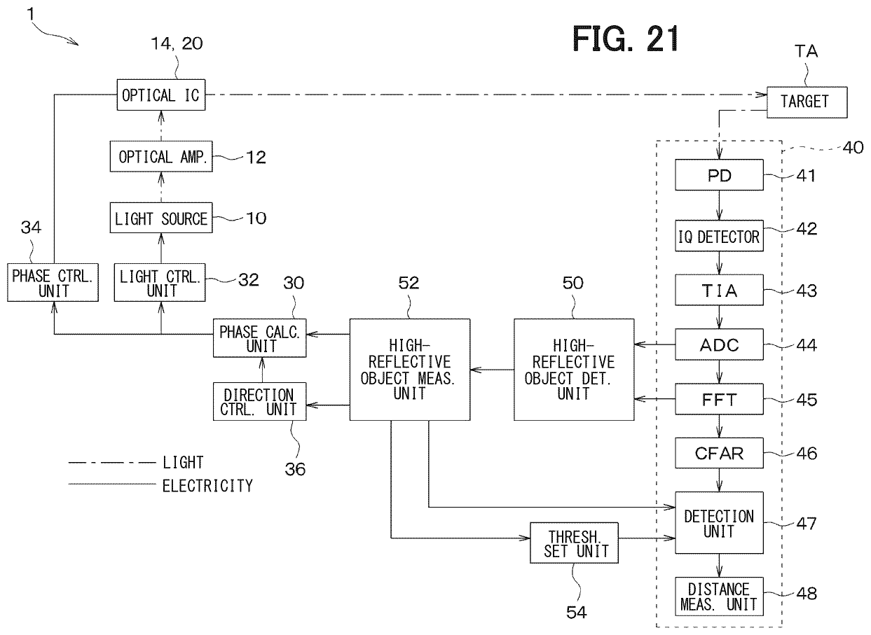

(Second Embodiment) Next, the second embodiment will be described with reference to FIGS. 21 to 23. This embodiment is different from the first embodiment in that the information regarding the size of the highly reflective object HR, which is calculated by the highly reflective object measurement unit 52, is output to the phase calculation unit 30 and the direction control unit 36, and a part of the detection processing executed by the target detection device 1. The other configurations are the same as those of the first embodiment. Thus, in this embodiment, the portions that differ from the first embodiment will be mainly described, and explanations of portions similar to those in the first embodiment may be omitted.

As shown in FIG. 21, the highly reflective object measurement unit 52 of the present embodiment is configured to calculate the size of the highly reflective object HR based on the information used to determine the presence of the highly reflective object HR, and output the calculated size information of the highly reflective object HR to the phase calculation unit 30 and the direction control unit 36.

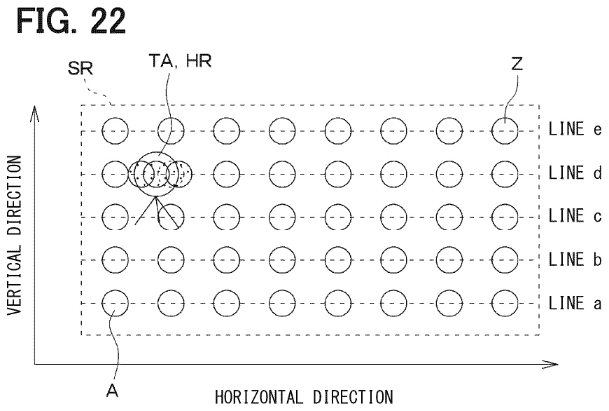

As shown in FIG. 22, the phase calculation unit 30 of this embodiment calculates the phase of the light such that gaps are formed within the irradiation range of the irradiation light when scanning each of the lines a to e in the horizontal direction. Additionally, the phase of the light is set so that the gaps between each irradiation light on the lines a to e remain constant. Then, the phase calculation unit 30 calculates the phase of the light so that the beam diameter emitted in each direction becomes substantially circular. The phase calculation unit 30 outputs the information of the calculated phase results of the light, as described above, to the light source control unit 32 and the phase control unit 34, thereby enabling scanning within the scan region. Accordingly, the target detection device 1 of the present embodiment requires fewer scans during frame scanning compared to the target detection device 1 of the first embodiment.

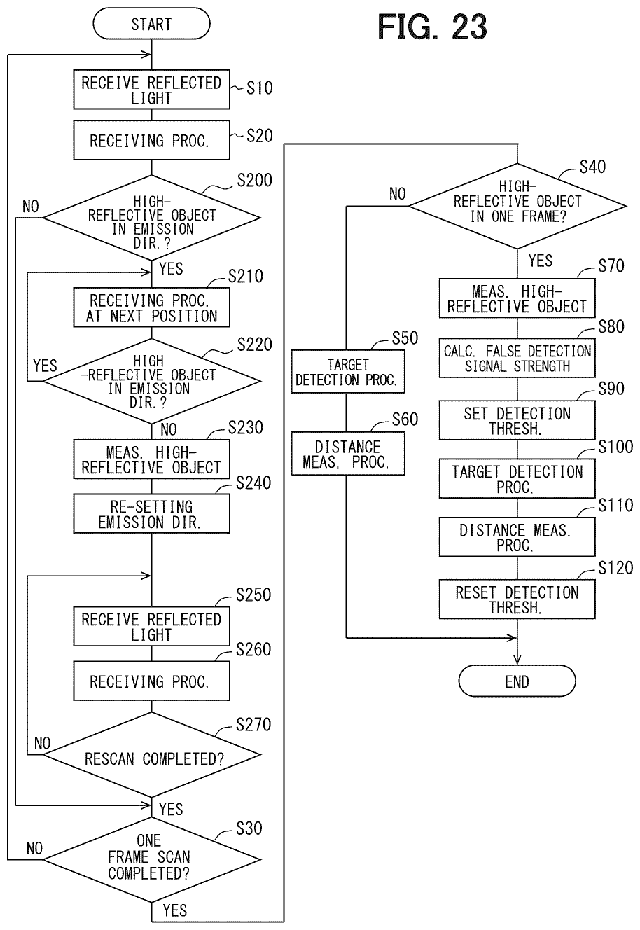

Next, the operation of the target detection device 1 of the present embodiment will be described with reference to the detection process shown in FIG. 23. Note that the processing in steps S10 to S120 of the detection process shown in FIG. 22 is the same as the processing in steps S10 to S120 described in the first embodiment using FIG. 7, and thus, detailed explanation of these processes may be omitted.

In the first embodiment, the detecting unit 40 executes the processing of step S20 each time reflected light is received until frame scanning is completed, and then executes the processing of step S30. Specifically, each time the reflected light corresponding to the emitted light in respective directions is received when the irradiation light is emitted for each of the lines a to e during the frame scanning, the detecting unit 40 executes the processing of step S20, and then the processing of step S30.

In the present embodiment, the detecting unit 40 of the target detection device 1 executes the processing of step S200 each time the reflected light is received during frame scanning. Specifically, the detecting unit 40 performs the light reception processing in step S20, and then the highly reflective object determination unit 50 determines whether the target TA that reflected the reflected light is a highly reflective object HR, based on the digital signal, the spectral signal, and the highly reflective object determination threshold in step 200. When the target TA is not determined to be a highly reflective object HR, the processing from step S210 to step S270 is skipped. In contrast, when the target TA is determined to be a highly reflective object HR, the processing from step S210 onward is executed.

In step S210, the detecting unit 40 performs the reception processing similar to that in step 20 at the next emission direction on the same scan line where the target TA that reflected the reflected light is determined to be a highly reflective object HR. For example, in this embodiment where each scan line in the scan region SR shown in FIG. 22 is scanned sequentially from left to right, the detecting unit 40 performs the receiving processing similar to that in step 20 at the emission direction just to the right of the emission direction where the target TA is determined to be a highly reflective object HR.

Then, in step S220, the highly reflective object determination unit 50 determines again whether the target TA that reflected the reflected light is a highly reflective object HR, based on the digital signal input from the ADC 44, the spectral signal input from the FFT 45, and the highly reflective object determination threshold. That is, the highly reflective object determination unit 50 determines whether a highly reflective object HR is present in the next emission direction.

The target detection device 1 repeatedly executes the processes of step S210 and step S220 on a single scan line until a highly reflective object HR can no longer be detected. Then, the highly reflective object determination unit 50 determines whether the target TA is a highly reflective object HR each time the light receiving process of step S20 is executed until the target TA is no longer determined to be a highly reflective object HR. The highly reflective object determination unit 50 outputs the determination results to the highly reflective object measurement unit 52 each time the target TA is a highly reflective object HR. Then, when the highly reflective object determination unit 50 no longer determines that a highly reflective object HR is present, the process of step S230 is executed.

In step S230, the highly reflective object measurement unit 52 calculates the size of the highly reflective object HR corresponding to the determination result identified as a highly reflective object HR by the highly reflective object determination unit 50, using a process similar to that of step S70. The highly reflective object measurement unit 52 calculates the size of the detected highly reflective object HR based on information regarding the distance to the highly reflective object HR and the direction to the highly reflective object HR. After the highly reflective object measurement unit 52 calculates the size of the highly reflective object HR, the highly reflective object measurement unit 52 outputs the information on the calculated size of the highly reflective object HR to the phase calculation unit 30 and the direction control unit 36.

When the direction control unit 36 receives information on the size of the highly reflective object HR from the highly reflective object measurement unit 52, the direction control unit 36 outputs a command signal to the phase calculation unit 30 to recalculate the phase of the light necessary to emit the irradiation light having the direction and the beam diameter required for re-scanning the highly reflective object HR.

When the phase calculation unit 30 receives information on the size of the highly reflective object HR from the highly reflective object measurement unit 52, and a command signal to recalculate the phase of the light from the direction control unit 36, the phase calculation unit 30 executes the process of step S240. In step S240, the phase calculation unit 30 calculates the phase of the light necessary to emit irradiation light with the direction and beam diameter required to rescan the area around the direction where the highly reflective object HR is present, which is determined by the highly reflective object measurement unit 52. Specifically, the phase calculation unit 30 calculates the necessary phase of the light so that the emission direction for re-scanning includes directions around the direction where the highly reflective object HR is present, which is determined by the highly reflective object measurement unit 52, excluding the emission directions during the previous frame scanning.

Furthermore, the phase calculation unit 30 calculates the phase of the light so that the interval of the irradiation light during re-scanning on the scan lines is smaller compared to before the highly reflective object HR is determined to be present. For example, in this embodiment, the phase calculation unit 30 calculates the phase of the light so that the irradiation ranges of the irradiation lights during re-scanning partially overlap with each other, as indicated by the hatched circles in FIG. 22. Then, the phase calculation unit 30 outputs the information of the calculated optical phase to the light source control unit 32 and the phase control unit 34.

The light source control unit 32 controls the light source 10 based on the signal input from the phase calculation unit 30. The phase control unit 34 controls the phase adjustment units 24 of the optical IC 14 based on the signal input from the phase calculation unit 30, thereby adjusting the direction of the irradiation light emitted from the OPA 20. As a result, the area, within the scan region, around the direction where the highly reflective object HR is determined to exist is rescanned at narrower intervals compared to before the highly reflective object HR is determined to exist in step S200. That is, the directions around the direction determined to include the highly reflective object HR are re-scanned at shorter scan intervals compared to when the frame scanning is performed.

Then, in step S250, the detecting unit 40 receives the reflected light generated by the irradiation light being reflected by the highly reflective object HR. In step S260, the detecting unit 40 performs the same light reception processing on the received reflected light as in step S20. The detecting unit 40 performs the light reception processing each time the re-scanning is performed in the direction where the highly reflective object HR exists and the reflected light from the highly reflective object HR is received.

The processing of step S250 and step S260 is repeatedly executed until it is determined that the re-scanning of the directions, which are reset in step S240, has been completed. When it is determined that the re-scanning has been completed, the processing of step S30 is executed.

As described above, when the highly reflective object determination unit 50 determines that there is a highly reflective object HR during the frame scan, the direction control unit 36 causes re-scanning before the frame scan is completed. Specifically, when it is determined that a highly reflective object HR is present during the frame scanning on one scan line among the five scan lines, the direction control unit 36 causes the one scan line where the highly reflective object HR has been determined to be present to be re-scanned before the frame scanning on the one scan line is completed.

It should be noted that the processing from step S30 to step S120 is the same as the processing from step S30 to step S120 described in the first embodiment. However, in this embodiment, when calculating the size of the highly reflective object HR in step S70, the highly reflective object measurement unit 52 calculates the size of the highly reflective object HR based on the information obtained in the light reception processing of step S260 among the processes from step S240 to step S270 described above. That is, the highly reflective object measurement unit 52 calculates the size of the highly reflective object HR based on the information regarding the distance and direction to the highly reflective object HR obtained by re-scanning the highly reflective object HR at narrower intervals compared to the frame scanning through steps S200 to S270.

Next, the reason for executing the processing from step S200 to step S270 in the detection process of this embodiment will be explained.

As described above, in the scan region SR scanned by the detection process of this embodiment, as shown in FIG. 22, the direction of the irradiation light in each scan line is set so that gaps are formed in the irradiation range of the irradiation light. In other words, compared to the target detection device 1 of the first embodiment, the number of scans during the frame scanning is reduced, thereby shortening the time required for the frame scanning. However, by setting the direction of the irradiation light in this manner, when a highly reflective object HR exists in the scan region SR, there is a possibility that the accuracy of calculating the size of the highly reflective object HR by the highly reflective object measurement unit 52 in the process of step S70 may decrease.

In contrast, when the target detection device 1 of this embodiment detects the presence of a highly reflective object HR during the frame scanning, the target detection device 1 executes the processing of steps S200 to S270 and re-scans the highly reflective object HR at narrower intervals compared to the frame scanning. Additionally, the target detection device 1 re-scans the highly reflective object HR by emitting irradiation lights in emission directions other than those set for the frame scanning.

Accordingly, even when the time required for the frame scanning is shortened, it is possible to accurately calculate the size of the highly reflective object HR. Thus, when determining the detection determination thresholds Dth using the size of the highly reflective object HR, the detection determination thresholds Dth can be set appropriately, and the target TA can be accurately detected using the appropriately set detection determination thresholds Dth.

Additionally, according to the above embodiment, the following effects can be obtained.

The target detection device 1 is configured to perform a re-scanning before the frame scanning on the one scan line is completed when the highly reflective object determination unit 50 determines that the target TA is a highly reflective object HR during the frame scanning on the one scan line among the multiple scan lines.

Accordingly, it is possible to estimate the size of the highly reflective object HR before the frame scanning on another scan line that is after the one scan line is performed, thereby reducing the time required to estimate the size of the highly reflective object HR. In addition, the target detection device 1 of the present embodiment includes the OPA 20 configured as a phased array, and performs the re-scanning by emitting irradiation light in an arbitrary direction through control of the light phase by the phase adjustment units 24. Thus, compared to configurations that use mechanical components such as movable mirrors to change the emission direction of the irradiation light, the emission direction of the irradiation light can be changed more easily and quickly, enabling the realization of such re-scanning.

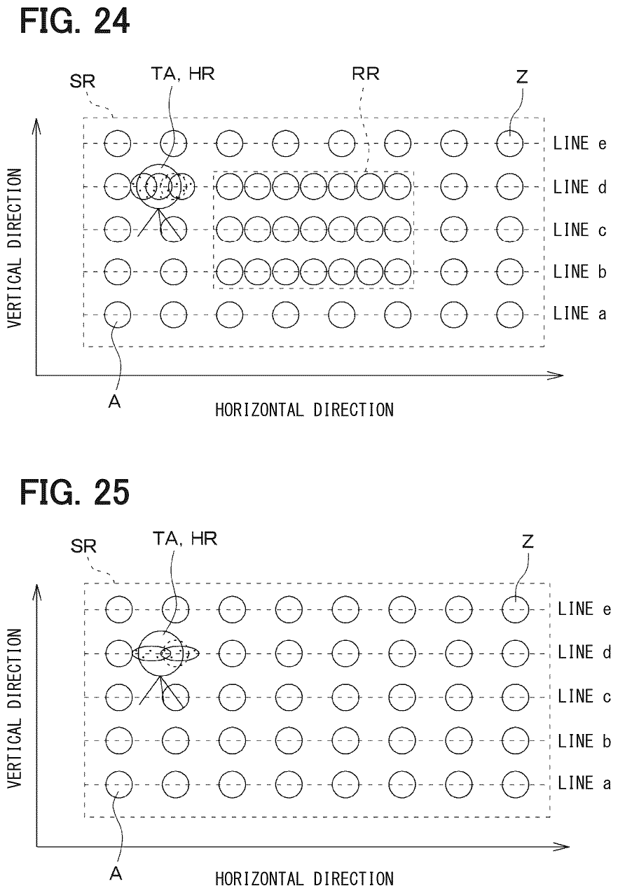

(First Modification of the Second Embodiment) In the above-described second embodiment, an example has been explained in which the phase calculation unit 30 sets the phase of the light such that the gaps between the irradiation lights emitted along each scan line constituting the frame scan are kept constant. However, the present disclosure is not limited to this. For example, as shown in FIG. 24, the phase calculation unit 30 may set the phase of the light such that the gaps between the irradiation lights become narrower in the ROI region RR, which is an area of interest that requires intensive scanning within the scan region SR of the frame scanning. The ROI region RR may be set at the center of the scan region SR. As a result, the detection accuracy of the target TA present in the ROI region RR can be improved, and the time required for the frame scanning can be shortened. It should be noted that ROI stands for Region of Interest.

In this case, when a highly reflective object HR is detected outside the ROI region RR, the phase calculation unit 30 may calculate the phase of the light so that the interval between the irradiation lights when scanning along the scan lines is smaller than that before the determination that the highly reflective object HR is present in step S240. When a highly reflective object HR is detected within the ROI region RR, the phase calculation unit 30 may calculate the phase of the light so that the interval between the irradiation lights when scanning along the scan lines is smaller than that before the determination that the highly reflective object HR is present in step S240. Alternatively, when a highly reflective object HR is detected within the ROI region RR, the phase calculation unit 30 may calculate the phase of the light so that the interval between the irradiation lights when scanning along the scan lines is the same as before the determination that the highly reflective object HR is present in step S240.

In this manner, even when an ROI region RR is set within the scan region SR and a highly reflective object HR exists outside the ROI region RR, the size of the highly reflective object HR can be accurately calculated. Thus, when determining the detection determination thresholds Dth using the size of the highly reflective object HR, the detection determination thresholds Dth can be set appropriately, and the target TA can be accurately detected using the appropriately set detection determination thresholds Dth.

(Second Modification of the Second Embodiment) In the above-described second embodiment, an example was explained in which, during the frame scanning, the phase calculation unit 30 calculates the phase of the light so that the beam diameter emitted in each direction is substantially circular. However, the present disclosure is not limited thereto. The phase calculation unit 30 may calculate the phase of the light so that the beam diameter emitted in each direction has an elliptical cross sectional shape. In this case, the beam diameter may be set to an elliptical shape extending in the horizontal direction, or to an elliptical shape extending in the vertical direction. It should be noted that, as shown in FIG. 25, by having the phase calculation unit 30 calculate the phase of the light so that the beam diameter has an elliptical shape extending in the horizontal direction, it becomes easier to shorten the time required for the frame scanning.

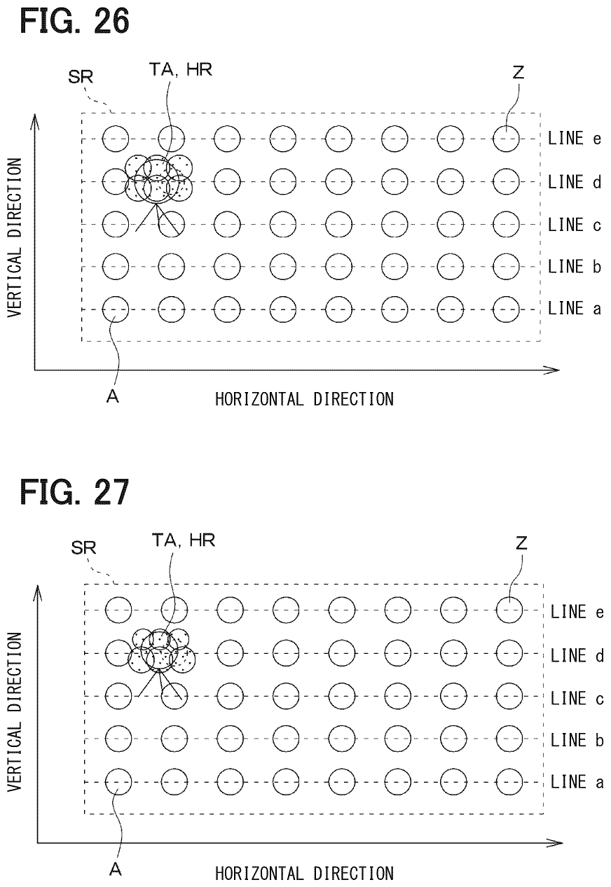

(Third Embodiment) Next, the third embodiment will be described with reference to FIG. 26. In this embodiment, a part of the detection processing executed by the target detection device 1 differs from that of the second embodiment. Other than this, the configuration is the same as in the second embodiment. Thus, in this embodiment, the description will primarily focus on the parts that differ from the second embodiment, and explanations of parts that are the same as those in the second embodiment may be omitted.

In this embodiment, when information on the size of the highly reflective object HR is input from the highly reflective object measurement unit 52, and a command signal for recalculating the phase of light is input from the direction control unit 36, the processing of step S240 executed by the phase calculation unit 30 differs from that of the second embodiment. Specifically, in step S240, the phase calculation unit 30 calculates the phase of light necessary to emit the irradiation light with the required direction and beam diameter in order to re-scan the vicinity of the direction in which the highly reflective object HR is present, which is determined by the highly reflective object measurement unit 52.

The phase calculation unit 30 calculates the phase of light to scan a line different from the scan line in which the highly reflective object HR is determined to be present. In other words, the phase calculation unit 30 calculates the phase of light necessary to set the emission direction for the re-scanning to a direction offset from the scan line during the frame scanning. In this embodiment, as indicated by the hatched circles in FIG. 26, the phase calculation unit 30 is configured to calculate the phase of light so that the emission directions are set to directions intersecting the horizontal direction along which the scan line, where the highly reflective object HR is detected, extends.

Specifically, the phase calculation unit 30 is configured to calculate the phase of light so that the emission directions are set to both the upper and lower vertical directions relative to the horizontal direction in which the scan line, where the highly reflective object HR is detected, extends. The phase calculation unit 30 is configured to calculate the phase of light so that the irradiation ranges of the irradiation lights partially overlap with each other and the beam diameters of the irradiation lights are equal to each other. Then, the phase calculation unit 30 outputs the information of the calculated optical phase to the light source control unit 32 and the phase control unit 34.

As a result, among the scan regions SR shown in FIG. 26, scanning an area near the direction, where it is determined that the highly reflective object HR exists, is performed again along a line different from the scan line where the presence of the highly reflective object HR has been determined. Then, when scanning is performed again in the area, the detecting unit 40 is configured to perform the light reception processing of step S20 each time receiving reflected light from the highly reflective object HR. Additionally, the highly reflective object measurement unit 52 is configured to calculate the size of the highly reflective object HR based on the information obtained from the light reception processing performed by the detecting unit 40.

Scanning the area near the direction determined to include the highly reflective object HR along a scan line different from the scan line where the presence of the highly reflective object HR has been determined, as described above, enables detection of the shape of the highly reflective object HR with high accuracy. For example, even when the highly reflective object HR has a smaller size in the vertical direction compared to its size in the horizontal direction, and the area of the highly reflective object HR that is illuminated by the frame scanning along the scan lines is small, the shape of the highly reflective object HR can be detected with high accuracy. Then, based on the highly accurate detection of the shape of the highly reflective object HR, the size of the highly reflective object HR can be calculated with high precision. Thus, when determining the detection determination thresholds Dth using the size of the highly reflective object HR, the detection determination thresholds Dth can be set appropriately, and the target TA can be accurately detected using the appropriately set detection determination thresholds Dth.

Furthermore, in cases where the highly reflective object HR has a smaller size in the vertical direction compared to its size in the horizontal direction, and only a portion of the illumination light strikes the highly reflective object HR during the frame scanning along the scan lines, there is a possibility that the signal intensity obtained through the light reception processing of this reflected light may be low. In this case, the received beam profile is altered compared to when all of the irradiation light is reflected by the highly reflective object HR.

However, by accurately detecting the shape of the highly reflective object HR, it is possible to determine the amount of change in the received beam profile. Thus, when calculating the false detection signal strength using the received beam profile, the false detection signal strength can be determined with high accuracy. Therefore, it is possible to accurately determine the detection determination thresholds Dth calculated based on the false detection signal strength, thereby further improving the detection accuracy of the target detection device 1.

(Modification of Third Embodiment) In the above third embodiment, an example has been described in which the phase calculation unit 30 is configured to calculate the phase of light so that the beam diameters are equal to each other when scanning lines other than the one scan line determined to include the highly reflective object HR. However, the present disclosure is not limited to this configuration. The phase calculation unit 30 may calculate the phase of light such that the beam diameters are different from each other when scanning lines other than the one scan line determined to include the highly reflective object HR.

In this case, the phase calculation unit 30 may calculate the phase of light such that the beam diameter when scanning the upper side from the one scan line, which is determined to include the highly reflective object HR, in the vertical direction is decreased compared to the beam diameter when scanning the lower side from the one scan line in the vertical direction, as shown in FIG. 27. Alternatively, although not shown in the figure, the phase calculation unit 30 may calculate the phase of light such that the beam diameter when scanning the upper side from the one scan line, which is determined to include the highly reflective object HR, in the vertical direction is increased compared to the beam diameter when scanning the lower side from the one scan line in the vertical direction. Alternatively, the phase calculation unit 30 may calculate the phase of light such that the beam diameters of the left end beam and the right end beam, among the beams along the one scan line which is determined to include the highly reflective object HR, are decreased compared to the beam diameter of the center beam.

It is possible to adjust the beam diameter of the irradiation light to correspond to a beam diameter suitable for the highly reflective object HR by adopting a configuration in which the beam diameter of the irradiation light can be arbitrarily varied according to the emission directions.

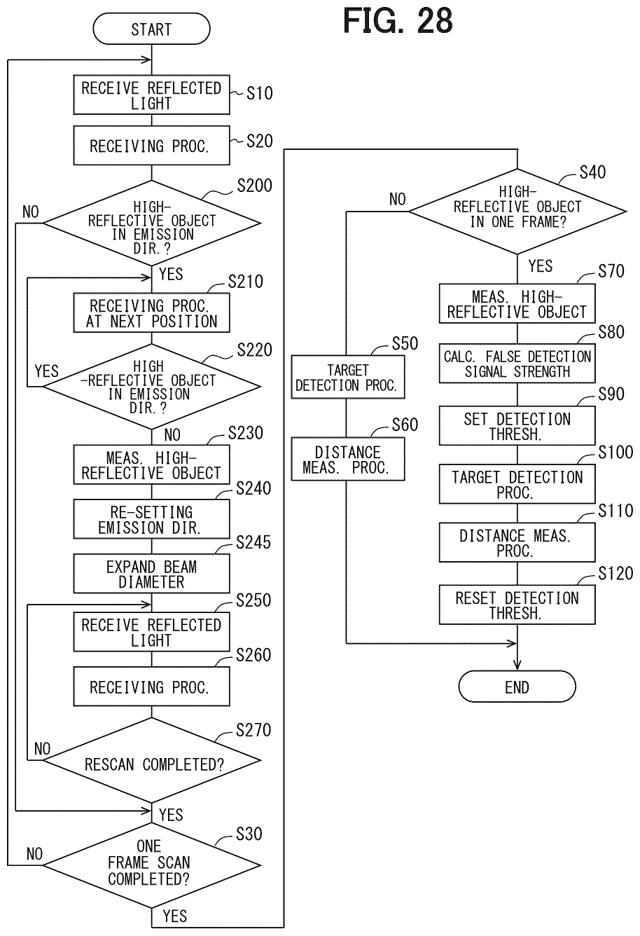

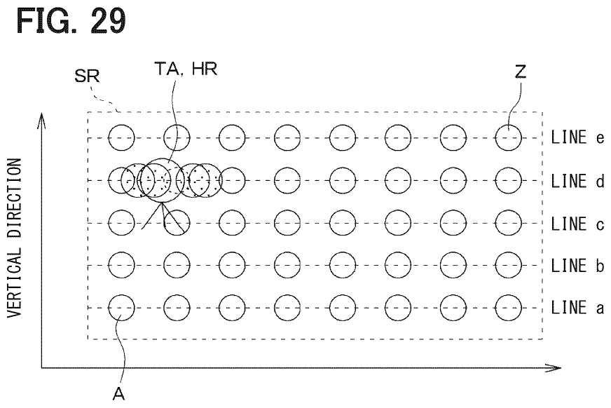

(Fourth Embodiment) Next, the fourth embodiment will be described with reference to FIG. 28 and FIG. 29. In this embodiment, a part of the detection processing executed by the target detection device 1 differs from that of the second embodiment. Other than this, the configuration is the same as in the second embodiment. Thus, in this embodiment, the description will primarily focus on the parts that differ from the second embodiment, and explanations of parts that are the same as those in the second embodiment may be omitted.

In this embodiment, when information regarding the size of the highly reflective object HR is input from the highly reflective object measurement unit 52, and a command signal to recalculate the phase of the light is input from the direction control unit 36, the phase calculation unit 30 executes the processing of step S245 after the processing of step S240. First, in step S240, the phase calculation unit 30 calculates the phase of the light necessary to irradiate the irradiation light in the emission direction required to re-scan the vicinity of the emission direction which is determined to include the highly reflective object HR by the highly reflective object measurement unit 52. Specifically, the phase calculation unit 30 calculates the phase of the light so that the emission direction of the irradiation light includes the direction where the highly reflective object HR is present, and so that the emission direction falls within the gap between the irradiation ranges of the irradiation light during the scan along the scan line in the horizonal direction.

Further, in step S245, the phase calculation unit 30 calculates the phase of the light so that the beam diameter of the irradiation light when scanning the scan line is a different size compared to that before the highly reflective object measurement unit 52 determined that the highly reflective object HR is present. In this embodiment, the phase calculation unit 30 calculates the phase of the light so that the beam diameter of the irradiation light emitted during re-scan is larger than the beam diameter of the emitted light during the frame scanning.

For example, as shown by the circles with hatching in FIG. 29, the phase calculation unit 30 of this embodiment calculates the phase of the light so that the irradiation light is directed toward the gaps on both the left and right sides of the direction where the highly reflective object HR has been determined to be present. Additionally, the phase calculation unit 30 calculates the phase of the light so that the beam diameter of the irradiation light directed toward these gaps is larger than the beam diameter of the irradiation light used to detect the highly reflective object HR. Then, the phase calculation unit 30 outputs the information of the calculated optical phase to the light source control unit 32 and the phase control unit 34.

As a result, within the scan region SR shown in FIG. 29, the scanning of the direction determined to contain the highly reflective object HR is performed again using a beam diameter larger than the beam diameter used to determine the presence of the highly reflective object HR. Then, when the scanning of the range determined to include the highly reflective object HR is performed again, the detecting unit 40 executes the light receiving process of step S260 each time receiving reflected light that has been reflected by the highly reflective object HR. Additionally, the highly reflective object measurement unit 52 is configured to calculate the size of the highly reflective object HR based on the information obtained from the light receiving processing performed by the detecting unit 40.

The scanning of the direction determined to include the highly reflective object HR with a beam diameter larger than the beam diameter used to determine the presence of the highly reflective object HR shortens the time required for the re-scanning that is executed to detect the size of the highly reflective object HR. Thus, even when re-scanning the direction determined to include the highly reflective object HR to obtain the size of the highly reflective object HR, it is possible to reduce the time required for the re-scanning.

In addition, setting the emission direction of the irradiation light to correspond to the gaps within the irradiation range where the presence of the highly reflective object HR has been determined, enables detection of the size of the highly reflective object HR with high accuracy. Furthermore, based on the accurately detected shape of the highly reflective object HR, the size of the highly reflective object HR can also be calculated with high accuracy. Thus, when determining the detection determination thresholds Dth using the size of the highly reflective object HR, the detection determination thresholds Dth can be set appropriately, and the target TA can be accurately detected using the appropriately set detection determination threshold Dth.

Although the present embodiment is a modification based on the second embodiment, it is also possible to combine the present embodiment with the aforementioned third embodiment. For example, when re-scanning the highly reflective object HR, it is possible to use a beam diameter larger than the beam diameter at which the presence of the highly reflective object HR has been determined, and to emit irradiation light both above and below the one scan line (in the vertical direction) where the presence of the highly reflective object HR has been determined.

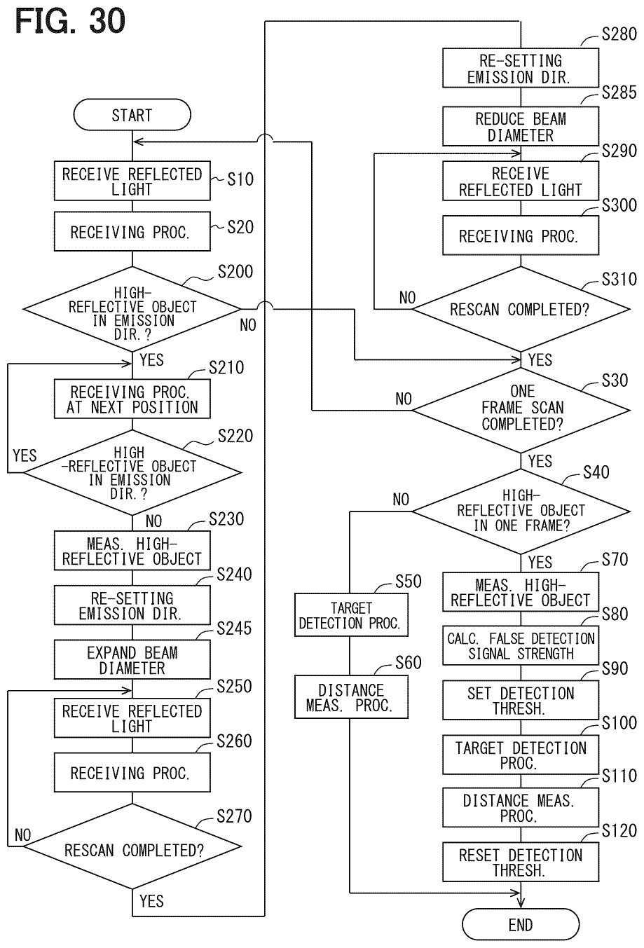

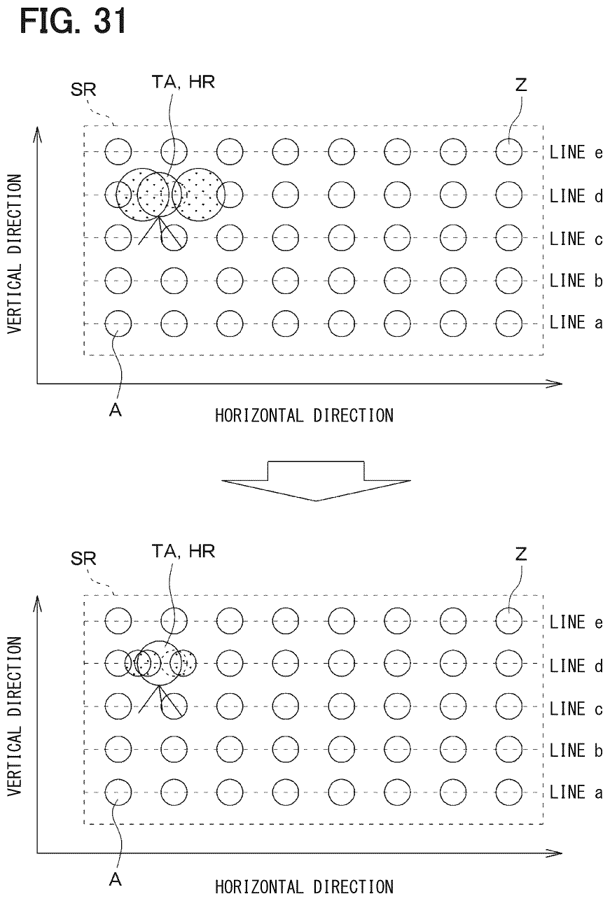

(Fifth Embodiment) Next, the fifth embodiment will be described with reference to FIG. 30 and FIG. 31. In the present embodiment, a part of the detection processing executed by the target detection device 1 differs from that of the fourth embodiment. Other configurations are the same as those in the fourth embodiment. Thus, in the present embodiment, the description will mainly focus on the parts that differ from the fourth embodiment, and the parts that are the same as the fourth embodiment may be omitted from the explanation.

In step S240 shown in FIG. 30, the phase calculation unit 30 calculates the phase of light such that the emission direction of the irradiated light includes the end portion of the direction in which the highly reflective object HR is present, and also the emission direction falls within a gap between the irradiation ranges of the irradiation light during the scan along the scan line in the horizontal direction. Furthermore, in step S245, the phase calculation unit 30 calculates the phase of the light so that, compared to before the highly reflective object HR is determined to be present by the highly reflective object measurement unit 52, the beam diameter of the irradiation light is larger when re-scanning the scan line.

For example, as shown by the hatched circles in the upper diagram of FIG. 31, the phase calculation unit 30 of the present embodiment calculates the phase of the light so that the irradiation light is directed to both the left and right sides of the direction in which the highly reflective object HR has been determined to be present. Specifically, the phase calculation unit 30 calculates the phase of the light so that a portion of the irradiation range of the irradiation light emitted to the left side of the direction in which the highly reflective object HR has been determined to be present overlaps with the left end of the irradiation range of the irradiation light that has been used to detect the presence of the highly reflective object HR. Furthermore, the phase calculation unit 30 calculates the phase of the light so that a portion of the irradiation range of the irradiation light emitted to the right side of the direction in which the highly reflective object HR has been determined to be present overlaps with the right end of the irradiation range of the irradiation light that has been used to detect the presence of the highly reflective object HR. Then, the phase calculation unit 30 outputs the information of the calculated optical phase to the light source control unit 32 and the phase control unit 34.

Then, by executing the processes of steps S250 to S270, scanning of the direction in which the highly reflective object HR is present is performed again using the expanded beam diameter. Additionally, the detecting unit 40 performs the light receiving process of step S260 each time receiving the reflected light from the highly reflective object HR, until it is determined that the re-scanning of the range where the highly reflective object HR is determined to exist has been completed. Then, in step S270, when it is determined that the re-scanning of the range where the highly reflective object HR is determined to exist has been completed, the process of step S280 is executed.

In step S280, the phase calculation unit 30 calculates the phase of the light so that the emission direction of the irradiation light includes both the direction in which the highly reflective object HR is present and the direction set by the process of step S240. Additionally, in step S285, the phase calculation unit 30 calculates the phase of the light so that the beam diameter of the irradiation light when scanning the scan line is smaller than the beam diameter set in step S245.

For example, in this embodiment, as shown by the hatched circles in the lower illustration of FIG. 31, the phase calculation unit 30 calculates the phase of the light so that a portion of the irradiation range of the irradiation light on the left side of the direction where the highly reflective object HR is present overlaps with a portion of the irradiation range of the irradiation light emitted with the large beam diameter. Additionally, the phase calculation unit 30 calculates the phase of the light so that a portion of the irradiation range of the irradiation light on the right side of the direction where the highly reflective object HR is present overlaps with a portion of the irradiation range of the irradiation light emitted with the large beam diameter. Furthermore, the phase calculation unit 30 calculates the phase of the light so that the edge of the highly reflective object HR detected by the irradiation light emitted with the large beam diameter can be detected. Then, the phase calculation unit 30 outputs the information of the calculated optical phase to the light source control unit 32 and the phase control unit 34.

Then, by executing the processes from step S290 to step S310, scanning of the direction in which the highly reflective object HR is present is performed again using the reduced beam diameter. The detecting unit 40 performs the light receiving processing of step S300 each time receiving the reflected light from the highly reflective object HR, until it is determined that the re-scan of the area where the highly reflective object HR is present is completed. Then, in step S310, when it is determined that the re-scan of the area where the highly reflective object HR is present is completed, the process of step S30 is executed.

Further, in the present embodiment, the highly reflective object measurement unit 52 calculates the size of the highly reflective object HR in step S70 based on information obtained in the light receiving processing of receiving the beam diameter set to be reduced in step S285 described above, and calculates the size of the highly reflective object HR. That is, the highly reflective object measurement unit 52 calculates the size of the highly reflective object HR based on the information regarding the distance and direction to the highly reflective object HR, which is obtained by re-scanning with a beam diameter smaller than the beam diameter set in step S245, through the processing from step S280 to step S310.

In this manner, the target detection device 1 of the present embodiment performs two rescans for re-scanning the direction where the highly reflective object HR is determined to be present. Then, by reducing the beam diameter of the irradiation light for each of the two rescans, the target detection device 1 can accurately detect the size of the highly reflective object HR. Thus, the detection determination thresholds Dth can be set appropriately when determining the detection determination thresholds Dth using the size of the highly reflective object HR, and the target TA can be accurately detected using the appropriately set detection determination thresholds Dth.

It should be noted that although the present embodiment is a modification based on the fourth embodiment, it is also possible to combine the present embodiment with the aforementioned third embodiment.

(Modification of Fifth Embodiment) In the above-described fifth embodiment, an example has been explained in which, upon re-scanning the direction determined to include the highly reflective object HR, the rescan is performed twice and the beam diameter is reduced as performing the re-scaning. However, the present disclosure is not limited to this. For example, when re-scanning the direction determined to include the highly reflective object HR, the target detection device 1 may perform three or more rescans and may reduce the beam diameter in two or more steps.

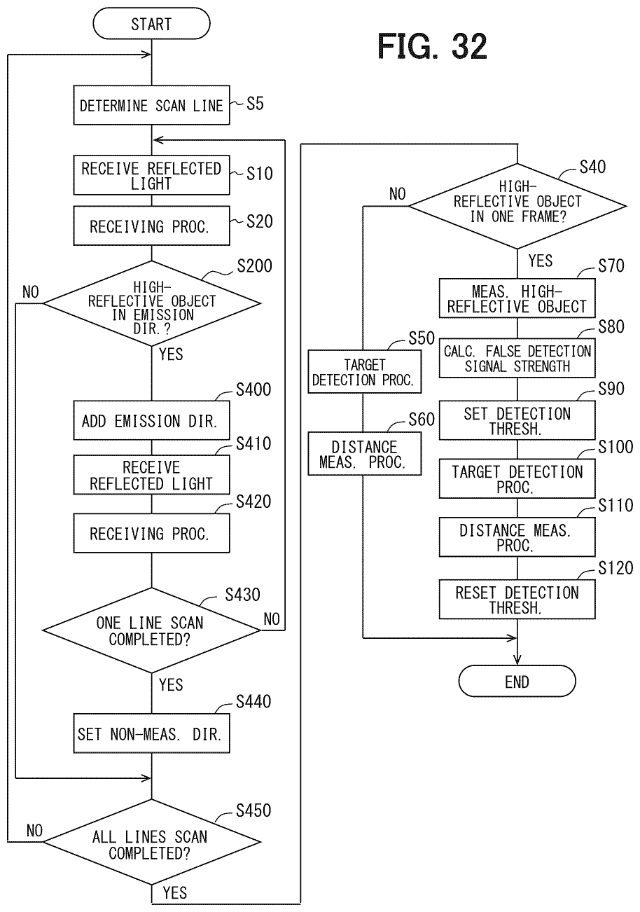

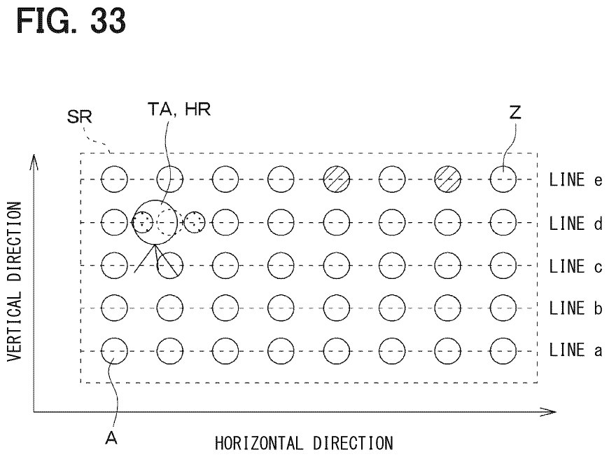

(Sixth Embodiment) Next, the sixth embodiment will be described with reference to FIGS. 32 and 33. In this embodiment, a part of the detection processing executed by the target detection device 1 differs from that of the second embodiment. Other than this, the configuration is the same as in the second embodiment. Thus, in this embodiment, the description will primarily focus on the parts that differ from the second embodiment, and explanations of parts that are the same as those in the second embodiment may be omitted.

In step S5 shown in FIG. 32, when performing the frame scanning, the direction control unit 36 outputs a command signal to the phase calculation unit 30 to calculate the phase of light necessary to emit irradiation light with the direction and beam diameter required for sequential scanning of each scan line. Upon receiving this command signal, the phase calculation unit 30 calculates the phase of light necessary to emit irradiation light with the direction and beam diameter required for sequential scanning of the scan lines. Then, the phase calculation unit 30 outputs the information of the calculated optical phase to the light source control unit 32 and the phase control unit 34.

As a result, the light generated by the light source 10 passes through the optical amplifier 12 and the optical IC 14, and is emitted from the OPA 20, thereby starting the scanning of a certain scan line within the scan region SR shown in FIG. 33. For example, when the frame scanning is started, scan along the scan lines from the line a. Then, in step S10, when the detecting unit 40 receives reflected light of the irradiation light reflected by the target TA, the detecting unit 40 performs a light receiving processing in step S20.

In the subsequent step S200, the highly reflective object determination unit 50 determines whether the target TA that reflected the reflected light is a highly reflective object HR or not. When the target TA is not determined to be a highly reflective object HR, the processing of steps S400 to S440 is skipped. When the target TA is determined to be a highly reflective object HR, the highly reflective object determination unit 50 outputs information on the determination result that the target TA is a highly reflective object HR to the phase calculation unit 30 and the direction control unit 36.

When the direction control unit 36 receives information on the determination result from the highly reflective object determination unit 50 indicating that the target TA is a highly reflective object HR, the direction control unit 36 executes the processing of step S400. Specifically, in step S400, the direction control unit 36 increases the number of the emission directions of the irradiation light compared to that before the highly reflective object HR has been determined in step S200. In other words, the direction control unit 36 increases the total number of emissions of the irradiation line for the one scan line during the frame scanning and the re-scanning compared to the number of emissions of the irradiation light for the one scan line during only the frame scanning. The direction control unit 36 outputs a command signal to the phase calculation unit 30 to recalculate the phase of the light necessary to emit in the increased directions.

When the phase calculation unit 30 receives information on the determination result from the highly reflective object determination unit 50 indicating that the target TA is a highly reflective object HR, as well as a command signal from the direction control unit 36 to recalculate the phase of the light, the phase calculation unit 30 executes the processing of step S410. Specifically, the phase calculation unit 30 calculates the phase of the light necessary to emit irradiation light required for scanning the vicinity of the direction in which the target TA that is a highly reflective object HR is present, which is determined by the highly reflective object determination unit 50. For example, in this embodiment, as indicated by the circles with hatching in FIG. 33, the phase calculation unit 30 calculates the phase of the light so that the irradiation light is directed toward the gaps on both the left and right sides of the direction in which the highly reflective object HR is determined to be present. Then, the phase calculation unit 30 outputs the information of the calculated optical phase to the light source control unit 32 and the phase control unit 34.

The light source control unit 32 controls the light source 10 based on the signal input from the phase calculation unit 30. The phase control unit 34 controls the phase adjustment units 24 of the optical IC 14 based on the signal input from the phase calculation unit 30, thereby adjusting the direction of the irradiation light emitted from the OPA 20. As a result, it is possible to scan the gaps in the irradiation range that exist on both sides of the direction in which the highly reflective object HR is determined to be present, within the scan region SR shown in FIG. 33.

Then, when scanning of both sides where the highly reflective object HR is determined to be present is performed again, in step S410, the detecting unit 40 receives the reflected light of the irradiation light whose direction is set to these increased directions on both sides. Further, in step S420, the detecting unit 40 performs the same light reception processing as in step S20 each time receiving the reflected light. Then, when the light reception processing for these two reflected lights is completed, the processing in step S430 is executed.

In step S430, the target detection device 1 determines whether the scanning of the scan line determined in step S5 has been completed. The target detection device 1 sequentially changes the emission direction of the irradiation light from left to right until the scanning of the scan line determined in step S5 is completed. In step S430, when it is determined that the scanning of the scan line determined in step S5 has been completed, the processing in step S440 is executed.

In step S440, the direction control unit 36 decreases the number of emitted irradiation lights by the same amount as the number increased in step S400, and outputs a command signal to the phase calculation unit 30 to recalculate the phase necessary to set the direction in which the number of emitted irradiation lights is to be decreased. That is, compared to the case where it is not determined that the highly reflective object HR is present in step S200, the direction control unit 36 outputs a command signal to the phase calculation unit 30 to recalculate the phase necessary to set the direction that is not be measured during the frame scanning.

When a command signal to recalculate the phase of light is input from the direction control unit 36, the phase calculation unit 30 extracts scan lines to be scanned after the scan lines that has been scanned through the execution of steps S400 to S440. Then, the phase calculation unit 30 decreases the number of emitted irradiation lights for scanning the extracted scan lines by the same amount as the number of irradiation lights increased in step S400, and calculates the phase of light necessary to set the direction in which the number of emitted irradiation lights is to be decreased.

For example, as shown in FIG. 33, in the scan along the line d, one of the irradiation lights emitted in a certain direction is reflected by the highly reflective object HR. In this case, through the processing of steps S400 to S440, as indicated by the hatched circles in FIG. 33, two irradiation lights are added to the directions on both sides of the irradiation light reflected by the highly reflective object HR, and irradiation lights are emitted in these increased directions. In this case, the phase calculation unit 30 extracts the line e as a direction to be scanned after the line d. Then, the phase calculation unit 30 decreases the number of irradiation lights emitted during the scan along the extracted line e by two, which is the same quantity as the two additional emissions increased in step S400, and calculates the phase of light necessary to set the directions in which the number of emitted irradiation lights is to be decreased. In FIG. 33, the emission directions of the irradiation lights that have been decreased are indicated by circles with diagonal hatching.

Here, the phase calculation unit 30 may reduce the emission of irradiation light in directions where the target TA is less likely to exist to minimize the impact of decreasing the number of emission directions. A direction where the target TA is less likely to exist refers, for example, to the direction in which the line e, which is the uppermost scan line in the vertical direction within the scan region SR, is scanned, that is, the direction in which the irradiation light is emitted upward toward the sky. Then, the phase calculation unit 30 outputs the information of the calculated phase results to the light source control unit 32 and the phase control unit 34. As a result, the number of the emission directions for the scan along the scan lines after the scan line with increased emission directions are reduced, and measurement in the reduced directions is no longer performed.

In step S450, the target detection device 1 determines whether the scan along all scan lines within the scan region SR has been completed. The target detection device 1 repeatedly executes the processes of step S5, step S10, step S20, step S200, and steps S400 to S450 until the scan along all scan lines is completed. Then, when it is determined that the scan along all scan lines has been completed, the process of step S40 is executed.

In this way, by scanning the gaps in the irradiation range on both sides of the direction determined to include the highly reflective object HR, it is possible to accurately detect the size of the highly reflective object HR. Thus, the detection determination thresholds Dth can be set appropriately when determining the detection determination thresholds Dth using the size of the highly reflective object HR, and the target TA can be accurately detected using the appropriately set detection determination thresholds Dth.

In addition, the target detection device 1 increases the number of emitted irradiation beams by two in the scan along the certain scan determined to include the highly reflective object HR, compared to the case where no re-scanning is performed, by conducting re-scanning before the completion of the scan along the certain scan line. Then, the target detection device 1 decreases the number of emitted irradiation beams in the scan performed after the scan along the certain scan line including the highly reflective object HR by two, compared to the case where no re-scanning is performed.

Thus, even when scanning of the gaps in the irradiation beams during the frame scanning is performed to accurately calculate the size of the highly reflective object HR, it is possible to suppress an increase in the time required to execute the detection process by reducing the number of emission directions for the scan along the subsequent scan lines.

In the above embodiment, an example has been described in which the number of emitted irradiation beams in the scan along the scan line determined to include the highly reflective object HR is increased by two through re-scanning, and, in contrast, the number of emitted irradiation beams in the scan for scan lines subsequently performed is decreased by two. However, the number of emitted irradiation beams to be decreased in the subsequently performed scan of the scan lines does not necessarily have to be the same as the increased number, as long as it is equal to or less than the number of beams that are increased. For example, as in the present embodiment where the number of emitted irradiation beams is increased by two through re-scanning, the configuration may alternatively decrease the number of emitted irradiation beams by one.

(Other Embodiments) The representative embodiments of the present disclosure have been described above. However, the present disclosure is not limited to the embodiments described above and may be variously modified as follows.

In the above embodiment, the target detection device 1 is applied to a vehicle V, and an example of detecting various targets TA present around the vehicle V has been described. However, the present disclosure is not limited thereto. The target detection device 1 of the present disclosure can be applied to equipment or objects other than vehicles V, and is capable of detecting various targets TA present around various types of equipment or objects on which the target detection device 1 is installed.

In the above embodiment, it goes without saying that the constituent elements of the embodiment are not necessarily essential except in cases where they are expressly indicated to be essential or are considered to be obviously essential in principle.

In the above embodiment, when the numbers, values, quantities, ranges, or the like of the components of the embodiment are mentioned, the present disclosure is not limited to such specific numbers except in cases where they are expressly indicated to be essential or are obviously limited to specific numbers in principle.

In the above embodiment, references to the shape or positional relationship of components, and the like, are not limited to those shapes or positional relationships unless expressly specified as essential or obviously limited to particular shapes or positional relationships in principle.

The phase calculation unit 30, the light source control unit 32, the phase control unit 34, the direction control unit 36, the highly reflective object determination unit 50, the highly reflective object measurement unit 52, and the threshold setting unit 54 of the present disclosure and their respective methods may be implemented by, as a controller, a dedicated computer comprising a processor and memory programmed to execute one or more functions embodied by a computer program. The phase calculation unit 30, the light source control unit 32, the phase control unit 34, the direction control unit 36, the highly reflective object determination unit 50, the highly reflective object measurement unit 52, and the threshold setting unit 54 of the present disclosure and their respective methods may be implemented by, as a controller, a dedicated computer provided by configuring a processor with one or more dedicated hardware logic circuits. The phase calculation unit 30, the light source control unit 32, the phase control unit 34, the direction control unit 36, the highly reflective object determination unit 50, the highly reflective object measurement unit 52, and the threshold setting unit 54 of the present disclosure and their respective methods may be implemented by, as a controller, one or more dedicated computers comprising a combination of a processor and memory programmed to execute one or more functions, and a processor configured with one or more hardware logic circuits. Further, the computer program may be stored as instructions to be executed by a computer on a non-transitory computer-readable tangible recording medium.

1. A target detection device configured to detect a target, the target detection device comprising:
a light source configured to generate light;
an emitting unit including an optical phased array configured to:
emit the light generated by the light source as an irradiation light in different emission directions within a scan region;
a detecting circuit configured to:
receive a reflected light from the target;
determine whether the target exists within the scan region for each of the emission directions based on whether a peak value of a received signal representing an intensity of the reflected light is equal to or greater than a detection determination threshold that is set for each of the emission directions; and
detect a direction among the emission directions in which the target exists;
a controller including at least one of (i) a circuit and (ii) a processor with a memory comprising a computer program code executable by the processor, the at least one of the circuit and the processor being configured to cause the controller to:
control the emission directions of the emitting unit to scan the scan region;
determine, based on the received signal, whether the detected target within the scan region is a highly reflective object that exhibits high reflectance to the irradiation light;
estimate, based on the received signal, a size of the highly reflective object; and
upon determining that the detected target in a specified direction among the emission directions is a highly reflective object, set the detection determination thresholds for remaining directions other than the specified direction, based on:
(i) the received signals of the reflected lights that are emitted in the remaining directions and reflected from the highly reflective object;
(ii) the estimated size of the highly reflective object;
(iii) a distribution of emission intensity of the emitting unit when emitting the irradiation light; and
(iv) a distribution of light-receiving sensitivity of the detecting circuit for the reflected lights.

2. The target detection device according to claim 1, wherein
the controller is configured to estimate the size of the highly reflective object based on a distance to the highly reflective object and the specified direction from which the reflected light is received from the highly reflective object.

3. The target detection device according to claim 1, wherein
the controller is configured to set higher detection determination thresholds for the remaining directions than strengths of the received signals of the reflected lights that are emitted in the remaining directions and reflected from the highly reflective object present in the specified direction.

4. The target detection device according to claim 1, wherein
the emission directions include a start emission direction and an end emission direction,
a frame scanning is defined as scanning the scan region from the start emission direction to the end emission direction,
the controller is configured to
perform re-scanning of an area around the specified direction by emitting the irradiation light in at least one emission direction other than the emission directions for the frame scanning upon determining that the target within the scan region is a highly reflective object,
the detecting circuit is configured to output a received signal of a reflected light that is generated by the re-scanning, and
the controller is configured to estimate the size of the highly reflective object based on the received signal generated by the re-scanning.

5. The target detection device according to claim 4, wherein
the scan region includes at least one scan line,
the irradiation light is emitted in the different emission directions along the at least one scan line for the frame scanning, and
the at least one emission direction in which the irradiation light is emitted for the re-scanning is offset from the at least one scan line.

6. The target detection device according to claim 4, wherein
the controller is configured to:
control a beam diameter of the irradiation light that is emitted by the emitting unit; and
set a different beam diameter of the irradiation light emitted during the re-scanning than the irradiation light emitted during the frame scanning.

7. The target detection device according to claim 6, wherein
the controller is configured to increase the beam diameter of the irradiation light emitted during the re-scanning compared to the beam diameter of the irradiation light emitted during the frame scanning.

8. The target detection device according to claim 6, wherein
the controller is configured to:
perform the re-scanning multiple times; and
decrease the beam diameter of the irradiation light as the re-scanning is performed.

9. The target detection device according to claim 6, wherein
the controller is configured to:
set multiple emission directions for the re-scanning; and
set different beam diameters of the irradiation light for the multiple emission directions.

10. The target detection device according to claim 6, wherein
the controller is configured to set the irradiation light emitted during the re-scanning to have an elliptical cross-sectional shape.

11. The target detection device according to claim 6, wherein
the emitting unit includes:
a plurality of optical antennas configured to emit the light generated by the light source; and
a phase adjustment unit configured to control a phase of the light emitted by each of the plurality of optical antennas to change the beam diameter of the irradiation light, and
the controller is further configured to cause the phase adjustment unit to change the beam diameter of the irradiation light by making a phase shift amount of the irradiation light non-linear or randomizing the phase shift amount.

12. The target detection device according to claim 4, wherein
the frame scanning is performed multiple times, and
the controller is configured to, upon determining that the detected target within the scan region is a highly reflective object during the frame scanning, estimate the size of the highly reflective object before a next frame scanning starts.

13. The target detection device according to claim 12, wherein
the scan region is divided by a plurality of scan lines,
the irradiation light is emitted in the different emission directions along each of the scan lines,
and
the controller is configured to, upon determining that the detected target within the scan region is a highly reflective object on one scan line among the scan lines, perform the re-scanning before completing the frame scanning on the one scan line.

14. The target detection device according to claim 13, wherein
the re-scanning is performed along the one scan line, and
the controller is configured to:
increase a total number of emissions of the irradiation light for the one scan line during the frame scanning and the re-scanning by a predetermined number compared to the number of emissions of the irradiation light for the one scan line during only the frame scanning; and
decrease a number of emissions of the irradiation light for another scan line after the one scan line during the frame scanning by the predetermined number or less.

15. The target detection device according to claim 1, wherein
the detecting circuit is configured to output, as the received signal, a digital signal corresponding to the intensity of the reflected light or a spectrum signal that is obtained by analyzing a frequency component of a signal corresponding to the intensity of the reflected light, and
the controller is configured to determine whether the target is a highly reflective object based on at least one of an amplitude of the digital signal, an amplitude of the spectrum signal, or a full width at half maximum of the spectrum signal.

16. A target detection device configured to detect a target, the target detection device comprising:
a light source configured to generate light;
an emitting unit including an optical phased array configured to:
emit the light generated by the light source as an irradiation light in different emission directions within a scan region; and
a direction control unit configured to control the emission directions of the emitting unit to scan the scan region;
a detecting unit configured to:
receive a reflected light from the target;
determine whether the target exists within the scan region for each of the emission directions based on whether a peak value of a received signal representing an intensity of the reflected light is equal to or greater than a detection determination threshold that is set for each of the emission directions; and
detect a direction among the emission directions in which the target exists;
a highly reflective object determination unit configured to determine, based on the received signal, whether the detected target within the scan region is a highly reflective object that exhibits high reflectance to the irradiation light;
a highly reflective object measurement unit configured to estimate, based on the received signal, a size of the highly reflective object; and
a threshold setting unit configured to, when the detecting unit detects that the target exists in a specified direction among the emission directions within the scan region and the highly reflective object determination unit determines that the detected target in the specified direction is a highly reflective object, set the detection determination thresholds for remaining directions other than the specified direction, based on:
(i) the received signals of the reflected lights that are emitted in the remaining directions and reflected from the highly reflective object;
(ii) the estimated size of the highly reflective object that is estimated by the highly reflective object measurement unit;
(iii) a distribution of emission intensity of the emitting unit when emitting the irradiation light; and
(iv) a distribution of light-receiving sensitivity of the detecting unit for the reflected lights.
